(19) United States
(12) Patent Application Publication
(10) Pub. No.: US 2021/0133678 A1
(43) Pub. Date: May 6, 2021

(54) SYSTEMS AND METHODS FOR LUGGAGE DELIVERY AND REDIRECTION DURING MID TRAVEL

(71) Applicant: Panasonic Avionics Corporation, Lake Forest, CA (US)

(72) Inventors: Steven BATES, Mission Viejo, CA (US); Philip WATSON, Lake Forest, CA (US)

(21) Appl. No.: 16/671,078

(22) Filed: Oct. 31, 2019

(51) Int. Cl. G06Q 10/08; H04L 29/08

(52) U.S. Cl. CPC G06Q 10/08355; H04L 67/12

(57) ABSTRACT

The present disclosure relates to systems and methods for redirecting luggage while in the midst of travel on a vehicle. An example system, carried by the vehicle, includes a distribution system for providing a vehicle communication network and a processor coupled to the vehicle communication network. The processor executes instructions to receive luggage identifying information and delivery parameters representative of passenger preferences from a user interface system carried by the vehicle and coupled to the vehicle communication network and generate one or more luggage redirection offers based on the received delivery parameters, receive a selection of a luggage redirection offer from the user interface system, and send messages representative of the selected redirection offer to a delivery service provider system, either automatically or queued for later delivery once communications with external systems are available.

### BACKGROUND

### Technical Field

The present disclosure relates generally to utilizing vehicle information systems for luggage redirection and more particularly, systems and methods for redirecting luggage using aircraft in-flight entertainment systems.

### Related Art

Transporting luggage to home or office from the airport once a passenger disembarks from an aircraft is one of the more cumbersome aspects of airline travel. Travelers (also referred to as passengers) must typically wait at luggage carousels for their luggage to appear, while the line outside of the airport for ground transportation steadily grows and subsequent arrangements are delayed. Additionally, delays and/or unavoidable scheduling may force business passengers to carry their luggage directly from the airport to a business meeting because they do not have sufficient time to check in at their hotel. Similarly, passengers may be forced to change travel arrangements and final destinations as a result of delays or cancelled flights.

Certain services exist that provide delivery of luggage to a destination of the passenger's choice. These services allow passengers to skip the wait at the luggage carousel and go straight from the arrival airport to any destination, whether a home, hotel, or office. Once a passenger has booked their travel itinerary, they can place an order with the luggage delivery service provider for a fee based on the number of items to be delivered and the distance to the delivery destination. The luggage delivery service provider then schedules the delivery logistics through their local agents. When the passenger arrives at the airport from which they are departing, the passenger can check their luggage as usual and pay any luggage fees owed the airlines operator.

However, current luggage delivery services must be selected before departing for the trip or at check-in. Several current delivery services require that an order be placed at least an hour prior to the departure of the aircraft. Once those opportunities have passed, passengers are not provided any other opportunities to schedule such services. Furthermore, passengers are unable to modify the delivery instructions after the opportunities have passed, for example, if the travel itinerary or the passenger's desired delivery destination changes. Further still, the delivery arrangements may be inflexible and restricted to the delivery service provider's local agents, without consideration of the traveler's preferences.

Example methods, systems and computer program products for generating personalized transportation proposals is described in US Application Publication 2017/0228667. Here, an update proposal to a passenger's travel itinerary may be generated based on an impact on the travel itinerary due to status information (e.g., delays in connecting flights, weather delays, traffic delays, etc.). The travel itinerary may be modified using the update proposal. In the event of an issue that causes the passenger's luggage is set to arrive at the destination airport after the passenger, the system may allow the user to input their contact information for later final destination delivery. However, the passenger is unable to neither provide any delivery preferences nor redirect the luggage delivery while they are in the midst of their. The passenger is merely able to provide contact information for later delivery, once the delayed luggage arrives at the destination, and such delivery is arranged by the airline or the airlines agent.

The present disclosure is directed toward overcoming one or more of the problems identified above and/or providing advantages over prior systems.

### SUMMARY

A system for redirecting luggage while in the midst of travel is disclosed herein. The system comprises a content distribution system configured to provide a vehicle communication network for a vehicle; at least one data store coupled to the vehicle communication network, the at least one data store configured to store luggage delivery instructions in association with luggage identifying information; and at least one processor coupled to the vehicle communication network and to at least one memory programmed with executable instructions. The content distribution system, the at least one data store, the at least one processor, and the at least one memory are each disposed in the vehicle. The at least one processor configured to execute the executable instructions to receive, from a user interface system carried by the vehicle and coupled to the vehicle communication network, luggage identifying information and delivery parameters representative of passenger preferences; generate one or more luggage redirection offers based on the received delivery parameters and transmit the one or more luggage redirection offers to the user interface system; receive a selection of a luggage redirection offer from the one or more luggage redirection offers from the user interface system; generate and store, in the at least one data store, luggage delivery instructions in association with the received luggage identifying information based on the selected luggage redirection offer; and send one or more messages to a delivery service provider system, the one or more messages containing information instructing the delivery service provider system to deliver luggage corresponding to the luggage identifying information according to the luggage delivery instructions associated with the luggage identifying information.

In another aspect, a method for redirecting luggage while in the midst of travel is disclosed herein. The method comprises receiving, from a user interface system carried by a vehicle and coupled to a vehicle communication network, luggage identifying information and delivery parameters representative of passenger preferences, the vehicle communication network provided by a content distribution system disposed on a vehicle; generating one or more luggage redirection offers based on the received delivery parameters and transmitting the one or more luggage redirection offers to the user interface system via the vehicle communication network; receiving, via the vehicle communication network, a selection of a luggage redirection offer from the one or more luggage redirection offers from the user interface system; generating and storing, in at least one data store disposed on the vehicle, luggage delivery instructions in association with the received luggage identifying information based on the selected luggage redirection offer; and sending one or more messages to a delivery service provider system, the one or more messages containing information instructing the delivery service provider system to deliver luggage corresponding to the luggage identifying information according to the luggage delivery instructions associated with the luggage identifying information

Other advantages and benefits of the disclosed system and methods will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 schematically illustrates an example luggage redirection system in accordance with the present disclosure;

FIG. 2A is a schematic block diagram of an example of a vehicle information system for installation on-board a vehicle that may comprise a portion of or the entirety of the redirection system of FIG. 1 in accordance with the present disclosure;

FIG. 2B is a schematic block diagram illustrating an example content distribution system in accordance with the present disclosure;

FIG. 3 schematically illustrates an example platform environment in accordance with the present disclosure;

FIG. 4 is an example method flow for redirecting luggage delivery whilst in mid-travel in accordance with the present disclosure;

FIGS. 5A and 5B are block diagrams illustrating example processes of the luggage redirection system in accordance with the present disclosure;

FIG. 6 schematically illustrates another example platform environment in accordance with the present disclosure;

FIG. 7 is an example method flow for providing status and location information whilst in mid-travel in accordance with the present disclosure;

FIG. 8 is another example method flow for providing status and location information whilst in mid-travel in accordance with the present disclosure; and

FIG. 9 illustrates a block diagram of a computing system, in accordance with various aspects of the present disclosure.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent that those skilled in the art will be able to understand the disclosure without these specific details. In some instances, well-known structures and components are shown in simplified form for brevity of description. Some of the surfaces have been left out or exaggerated for clarity and ease of explanation.

As used herein, the terms “environment,” “platform,” “component,” “module,” “system,” and the like as used herein are intended to refer to a computer-related entity, either software-executing general purpose processor, hardware, firmware or a combination thereof. For example, a component may be, but is not limited to being, a process running on a hardware processor, a hardware processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer/machine readable media including, but not limited to, an ASIC (application specific integrated circuit), CD (compact disc), DVD (digital video disk), ROM (read only memory), hard disk, EEPROM (electrically erasable programmable read only memory), solid state memory device or any other storage device, in accordance with the claimed subject matter.

The term “user” is used herein to refer to any person or entity that uses or otherwise interacts with the systems described here. User may refer to an operator, passenger, occupants, travelers, crew members, or any person or entity who interacts with any part of the systems described herein. The term “passengers” and/or “travelers” may refer to any persons who are customers or otherwise being transported by the vehicle who may use or otherwise interact with the systems described here.

References throughout this specification to “an embodiment” or “an implementation” means that a particular feature, structure, or characteristic described in connection with the embodiment is included in at least one embodiment or implementation. Thus, appearances of the phrase “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The present disclosure is directed to an innovative luggage redirection system that facilitates redirection of luggage based on passenger defined redirection preferences whilst the passenger is traveling, such as whilst in mid-flight while on an aircraft or other transportation vehicle. The system includes a backend server hosting an application communicatively coupled to an application executed on user interface systems operated by a passenger carried by the vehicle, such as personal electronic devices (“PEDs”) and/or devices coupled to inflight entertainment (“IFE”) systems or inflight entertainment and communication (“IFEC”) systems that facilitate communications whilst the passenger is in mid-flight. Embodiments herein provide advantages over conventional systems by utilizing in-flight communications systems to facilitate redirecting and viewing real-time status of luggage delivery services while the passenger is in route to their final destination. That is, the passenger may be utilize systems described herein while on an aircraft or otherwise subsequent to check-in at an originating airport. As used herein, IFE systems may refer to systems capable of providing vehicle entertainment services without connectivity, while IFEC systems may refer to systems capable of providing vehicle entertainment services and connectivity services (e.g., services such as Internet browsing, text messaging, cell phone usage (where permitted), and emailing). However, embodiments described herein are equally applicable to both IFE and/or IFEC systems.

Conventional luggage delivery systems redirecting luggage delivery, either based on passenger defined preferences or otherwise, as such services must be selected before departing for the trip or at check-in (e.g., an hour before departure). Once those opportunities have passed, the conventional systems are unable to schedule or modify the scheduled delivery, thus these conventional systems were unable to either arrange luggage delivery or redirect it while the passenger is traveling. For example, the destination of a piece of luggage is determined and set once a luggage tag is placed on the luggage. The passenger thenceforth has no way to redirect the destination of the luggage, because there is no mechanism providing communications between the passenger and systems handling luggage. However, after dealing with luggage on the way to the airport, the passenger may not wish to do so again, and may wish to have luggage delivered to their destination, without having to wait to claim the bags at the airport. As another example, the passenger's travel itinerary may be changed, for example due to flight cancellation, reroutes, etc. or changes in hotel arrangements, other accommodation plans, or final destination plans and the passenger may wish to redirect the location and/or time for delivery of their luggage. Embodiment of the innovative redirection system provide passengers a means to access these services and modify them, as desired by the passenger, where such an opportunity would not otherwise exist, for example, by leveraging a vehicle communication system (such as an IFEC system) that can store passenger information (such as personal identity information and/or personal data information and provide passenger communications of luggage delivery preferences to ground systems that can reroute luggage.

For example, various embodiments described herein provide for a software application stored as instructions in a memory of a passenger's PED (sometimes referred to herein as a device memory) that are executable by a processor of the passenger's PED (sometimes referred to herein as a device processor). By executing the software application, a graphical user interface (“GUI”) may be generated through which the passenger may input delivery preferences, such as registering for luggage delivery service and/or input criteria for the luggage delivery (referred to herein as delivery parameters). The passenger may input one or more of itinerary identification information and luggage identifying information into screens generated by the GUI and/or scan luggage identifying information (e.g., using a camera or other imaging device coupled to the PED, radio frequency identification reader, or identification readers). In some embodiments, PED may comprise an electronic boarding pass stored in the device memory, and the electronic boarding pass may be loaded to or otherwise accessible to the software application. The software application may be configured to extract luggage identification information using the electronic boarding pass. Where the passenger and PED are in flight, the PED may communicate with the IFEC system on the aircraft, via a communication network supplied by the IFEC system, to record, to the IFEC server, updated luggage delivery information or replace existing luggage delivery information. Existing luggage delivery information may be conventional instructions to process luggage to baggage claim. The luggage delivery information may be associated with the luggage identification information and/or itinerary identification information that identify the passenger's itinerary. If the passenger is on the ground (e.g., not yet departed the airport on take-off or has landed at an airport), the PED may utilize the software application to communicate the delivery preferences to the delivery service provider over any available communication network (e.g., wired, Wi-Fi, cellular network, etc.). The recorded luggage delivery information may be immediately communicated to a ground-based luggage delivery system, where bidirectional communication is available, or queued into the IFEC system for transmission upon landing. The delivery service provider may then schedule the delivery in accordance with the recorded instructions. In some embodiments, the above described software application may be pre-loaded into a device memory integrated with a mode of transportation and connected to an internal network system of the mode of transportation (e.g., interactive screen on the back of the headrest on an airplane), such as in-seat and/or seatback devices including a monitor display (interchangeably referred to herein as in-seat device).

Another embodiment provides using the IFEC system of the aircraft, for example, via a browser-based portal application. The browser-based portal application may hosted by the IFEC system and accessed via a browser application executed at a PED and/or in-seat device.—In this embodiment, the passenger may follows the same steps as above described software application embodiment; namely, the passenger elects to schedule and/or modify luggage delivery service, enters or scans identification information (or if the electronic boarding pass is already loaded, no passenger entry is required), and then, using built-in wireless communications to the aircraft, the IFEC system records the preference to the onboard server. The record is either immediately communicated to the ground, or is queued and sent only upon landing.

A non-limiting advantage of the various embodiments described in the present disclosure is that if the passenger has previously registered for luggage delivery services, the passenger can utilize the luggage redirection systems disclosed herein while on a flight or between connecting flights, which was not possible in the conventional systems. As such, passengers can query a status of the luggage delivery using the IFEC system, such as a location (e.g., the luggage may be on a different, earlier or later flight or otherwise in transit on the ground) and an expected delivery time or change thereof for the delivery. The passenger may be able to change the desired delivery location and time based on passenger preferences and/or flight particulars (sometimes referred to herein as travel variables), e.g., delayed flight, inclement weather, change aircraft, aircraft circling airport before landing, or other changed circumstances in their flight plan or flight objective(s).

As another example advantage, the luggage redirection system can communicate with the passenger either via on-board or vehicle communication services (e.g., local Wi-Fi to an intranet or to the Internet) to the PED and/or in-seat device and provide one or more luggage redirection offer(s) based on one or more passenger defined delivery parameters or criteria. Luggage redirection offer(s) may include delivery instructions and logistics for processing and delivery of the passenger's luggage, for example, identification of the luggage, identification of the scheduled pickup and delivery services and handlers, identification of the time and destination for delivery, route information, etc. The redirection could be as simple as sending the luggage to your final destination, home, hotel, cruise ship, bus, etc or more complex in terms of allowing for cleaning, separation of specific luggage items, even pickup and transport of duty free items.

Embodiments herein may advantageously be configured to evaluate passenger delivery parameters as part of generating the one or more redirection offers, which the passenger may interact with and select one or more redirection offer for scheduling luggage delivery defining the passenger's preferred or desired delivery criteria. Delivery parameters input by the passenger may include one or more of pricing parameters, delivery service providers, delivery destinations, delivery time parameters, and delivery instructions information (e.g., detailed explanation as to where to drop off and who may accept delivery). In some embodiments, delivery parameters may also include indication that cleaning of luggage is permitted and/or requested, an indication that multiple pieces of luggage may be separated and separately delivered, a request for pickup and delivery of items purchased during travel (e.g., duty free items, retail items, etc.).

Pricing parameters may include, but not limited to, price thresholds defining preferred price ceilings, price floors, and/or a price window. Desired delivery service provider may include, not limited to, a private car delivery, commercial delivery services (e.g., FedEx®, UPS, etc.), commercial van couriers, ride-share delivery services (e.g., Uber™, Lyft™, etc.), drone or other automated robotic delivery service, election of drop-off or pick-up services, or any combination thereof to route the luggage to the destination. Desired delivery destinations and accommodations may include, but are not limited to, the passenger's home, hotel, lodging rental marketplaces (e.g., Airbnb®. VRBO®, etc.), a residential location of another person's, an office or other business location, recreational locations (e.g., golf course, ski resort, etc.), or the geographic location. The location may include an address, location name, or other identifying information. Delivery timing parameters may include one or more of a desired delivery time or window.

Various embodiments may retrieve one or more travel variables that may impact a passenger's travel itinerary and/or luggage delivery. Travel variables may be obtained through access to flight data stored in the aircraft or airline operator systems. Travel variables may include, but not limited to, delays in connecting flights, weather delays, traffic delays, expected time of arrival of the passenger, expected time of arrival of luggage (if on a different flight), distance from arrival location (e.g., airport), etc. As yet another example, embodiments herein may access third party systems via wireless communications to retrieve third party delivery variables that may impact the scheduling and logistics of the one or more redirection offers. Example third party systems include systems external or otherwise remote of the PED and/or IFEC systems described herein, for example but not limited to, airline operator systems, weather forecasting systems, delivery service provider systems, delivery locker systems, pickup systems, pickup locker systems, or the like.

The travel variables and/or delivery variables may be evaluated in conjunction with passenger delivery parameters as part of generating the one or more redirection offers. For example, luggage redirection offers may be based on price quotes from third party systems (e.g., delivery service providers) and filtered based on the passenger desired pricing parameters, Luggage redirection offers may also be based on one or more desired delivery service providers that are available to deliver the luggage to the identified destination, for example, based on the desired time of delivery and availability of luggage handlers to perform delivery. Luggage redirection offers may include an indication of cost trade-off (e.g., which variables affect the costs), or surge-pricing. The passenger may then be able to filter based on the trade-offs and/or remove redirection offers impacted by surge-pricing.

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or passenger control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application. Similarly, the various processes and methods described herein may be described with reference to flow charts having process blocks illustrated in a particular sequence. However, the example implementations are not limited to the particular sequence illustrated. Example implementations may include actions being ordered into a different sequence as may be apparent to a person of ordinary skill in the art or actions may be performed in parallel or dynamically, without departing from the scope of the present application.

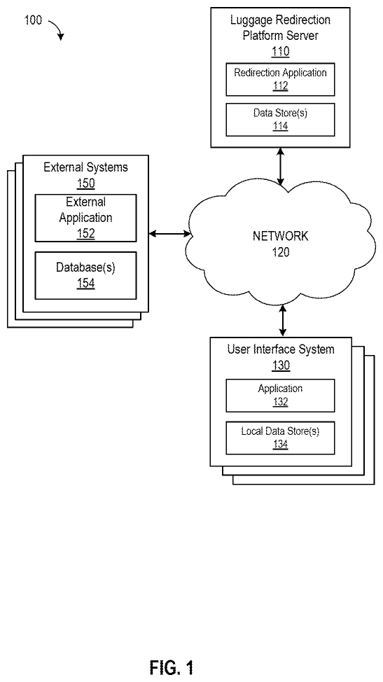

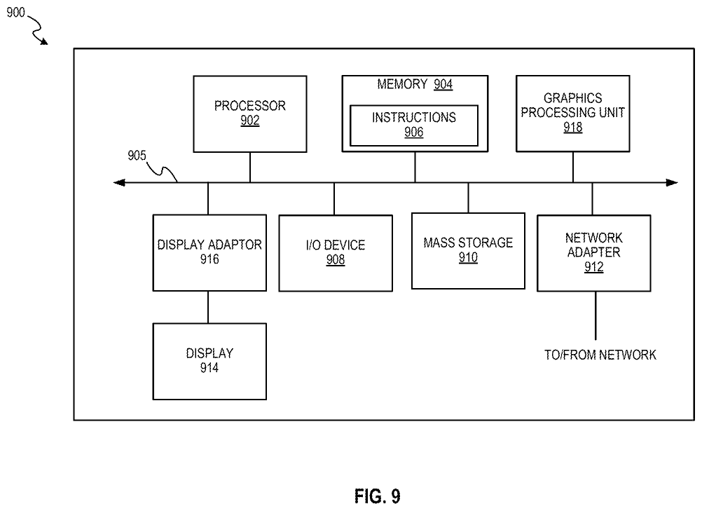

FIG. 1 schematically illustrates an example luggage redirection system in accordance with the present disclosure. The infrastructure of the luggage redirection system 100 shown in FIG. 1 comprises a luggage redirection platform server 110 (referred to herein as platform server 110) which hosts and/or executes one or more of the various functions, processes, and/or methods described herein of the luggage redirection system 100. Platform server 110 may comprise one or more dedicated servers, or may instead comprise cloud instances, which utilize shared resources of one or more servers. These servers or cloud instances may be collocated and/or geographically distributed. Platform server 110 may also comprise or be communicatively connected to luggage redirection application 112 and/or one or more data stores 114. In addition, platform server 110 may be communicatively connected to one or more user interface systems 130 via network 120. Platform server 110 may optionally be communicatively connected to one or more external systems 150 (e.g., websites, apps, other servers, etc.) via network 120. External systems 150 may host third party systems or remote services and/or resources. Platform server 110 may be implemented as one or more computing devices such as, for example, computing device 900 illustrated in FIG. 9 discussed below.

Network 120 may include the Internet and/or an intranet, and platform server 110 may communicate with user interface system(s) 130 through the network 120 using standard transmission protocols, such as HyperText Transfer Protocol (HTTP), Secure HTTP (HTTPS), File Transfer Protocol (FTP), FTP Secure (FTPS), SSH FTP (SFTP), and the like. While platform server 110 is illustrated as connected to various systems through a single set of network(s) 120, it should be understood that platform server 110 may be connected to the various systems via different sets of one or more networks. For example, platform server 110 may be connected to a subset of user interface systems 130 and/or external systems 150 via the Internet, but may be connected to one or more other user interface systems 130 and/or external systems 150 via an intranet. As another example, network 120 may be or otherwise include an internal network system include in a mode of transportation (e.g., a vehicle such as an aircraft or transportation vehicle) that connects user interface systems 130 carried by the mode of transportation to the platform server 110. Network 120 may also include any wired or wireless network, for example, a cellular network (e.g., 3G, 4G LTE, 5G, etc.), local area network (LAN), wide area network (WAN), etc. Furthermore, while only a few user interface systems 130, external systems 150, application 112, and one set of database(s) 114 are illustrated, it should be understood that the infrastructure may comprise any number of user interface systems, external systems, server applications, and databases.

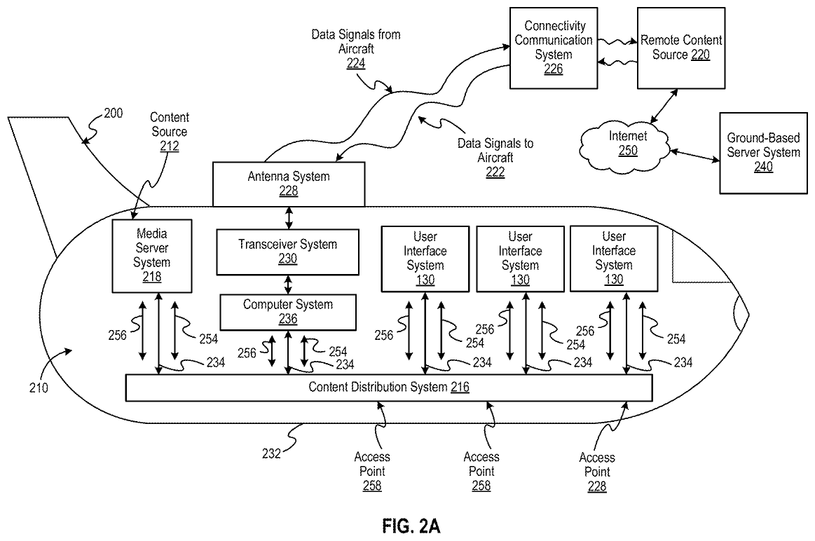

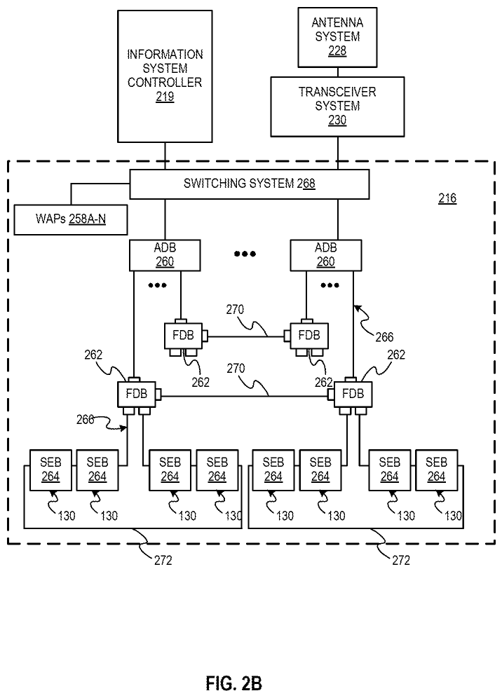

User interface system(s) 130 may comprise any type of computing devices capable of wired and/or wireless communication. Example user interface systems 130 may include PEDs through which a user is able to interface with the platform server 110, which may include any PEDs having wireless communication capability, such as cellular phones, smart phones, tablet computers, laptop computers, and other portable electronic devices (PEDs), a digital electronic media device, wearable smart electronic device, smart watch, any mobile electronic device, and the like. FIG. 9 illustrates an example computing device 900 that may be implemented as a user interface system 130. User interface systems 130 may also be a device that is integrated with a mode of transportation and connected to an internal network system of the mode of transportation (e.g., interactive screen on the back of the headrest on an airplane), such as in-seat and/or seatback devices including a monitor display (interchangeably referred to herein as in-seat device). FIG. 2 illustrates an example mode of transportation comprising user interface systems 130.

Platform server 110 may comprise web servers which host one or more websites, web services, and/or Internet-based applications. In embodiments in which a website is provided, the website may comprise a GUI generating one or more user interface screens, including, for example, webpages generated in HyperText Markup Language (HTML) or other language and displayed on the user interface systems 130. Platform server 110 transmits or serves the GUI in response to requests from user interface system(s) 130. In some embodiments, the GUI may be served in the form of a wizard, in which case two or more user interface screens may be served in a sequential manner, and one or more of the sequential user interface screens may depend on an interaction of the user or user interface system 130 with one or more preceding user interfaces. The requests to platform server 110 and the responses from platform server 110, including the screens, may both be communicated through network 120. These user interface screens or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more data stores (e.g., data stores 114) that are locally and/or remotely accessible to platform server 110. Platform server 110 may also respond to other requests from user interface system(s) 130.

Platform server 110 may further comprise, be communicatively coupled with, or otherwise have access to external systems 150. The external systems 150 may be configured to provide third party services and/or information based on requests received from the platform server 110. For example, the platform server 110 may communicate with the external systems 150 to request data or request execution of third party services via network 120 and obtain information from third party systems. The request from platform server 110 may be communicated based on inputs received from user interface systems 130 at the platform server 110 so to facilitate or otherwise complete the request. External systems 150 may include their own dedicated servers 152 executing application and database(s) 1514 for executing functions thereof and storing data for executing those functions. Example third party systems may include, but are not limited to, systems external or otherwise remote of the platform server 110 and/or user interface systems 130 described herein, for example but not limited to, airline operator systems, transportation service provider systems, luggage handler systems, weather forecasting services, or the like.

Platform server 110 may further comprise, be communicatively coupled with, or otherwise have access to one or more data stores 114. For example, platform server 110 may comprise one or more servers which manage one or more data stores 114. A user interface system 130 or application 112 executing on platform server 110 may submit data (e.g., user data, form data, etc.) to be stored in data store 114 and/or request access to data stored in data store 114. Any suitable database may be utilized, including without limitation MySQL™, Oracle™, IBM™, Microsoft SQL™ Sybase™, Access™, and the like, including cloud-based database instances and proprietary databases. Data may be sent to platform server 110, for instance, using the well-known POST request supported by HTTP, via FTP, etc. This data, as well as other requests, may be handled, for example, by server-side web technology, such as a servlet or other software module (e.g., application 112), executed by platform server 110.

In embodiments in which a web service is provided, platform server 110 may receive requests from user interface systems 130 and/or external system(s) 150, and provide responses in eXtensible Markup Language (XML) and/or any other suitable or desired format. In such embodiments, platform server 110 may provide application programming interfaces (API) software development kits (SDK) which define the manner in which user interface system(s) 130 and/or external system(s) 150 may interact with the web service. Thus, user interface system(s) 130 and/or external system(s) 150 (which may each themselves be servers) can define their own user interfaces and rely on the web service to implement or otherwise provide the backend processes, methods, functionality, storage, etc., described herein.

For example, in such an embodiment, a client application 132 executing on one or more user interface system(s) 130 may interact with a application 112 executing on platform server 110 to execute one or more or a portion of one or more of the various functions, processes, methods, and/or software modules described herein. Client application 132 may be “thin,” in which case processing is primarily carried out on the backend by application 112 on platform server 110. An example of a thin client application is a browser-based portal application, which requests, receives, and renders webpages at user interface system(s) 130, while the application 112 on platform server 110 is responsible for generating the webpages and managing database functions. Alternatively, the client application may be “thick,” in which case processing is primarily carried out client-side by user interface system(s) 130, for example, as a software application installed on the user interface system 130. It should be understood that client application 132 may perform an amount of processing, relative to application 112 on platform server 110, at any point along this spectrum between “thin” and “thick,” depending on the design goals of the particular implementation. In any case, the application described herein, which may wholly reside on either platform server 110 (e.g., in which case application 112 performs all processing) or user interface system(s) 130 (e.g., in which case application 132 performs all processing) or be distributed between platform server 110 and user interface system(s) 130 (e.g., in which case application 112 and client application 132 both perform processing), can comprise one or more executable software modules that implement one or more of the processes, methods, or functions of the application(s) described herein.

Similarly, application 112 may interact with an external or third party application executing on external system 150 to execute one or more or a portion of one or more of the third party functions, processes, methods, and/or software modules and retrieve information based thereon. The external system 150 may provide an API and/or SDK which defines the manner in which platform server 110 may interact with the web services provided by the external system 150. Application 112 may be “thin,” in which case processing is primarily carried out by the external system 150. Alternatively, the application 112 may be “thick,” in which case processing is primarily carried out by platform server 110. It should be understood that platform server 110 may perform an amount of processing, relative to external system 150, at any point along this spectrum between “thin” and “thick,” depending on the design goals of the particular implementation. In any case, the application described herein, which may wholly reside on either platform server 110 or external system 150 or be distributed between platform server 110 and external system 150, can comprise one or more executable software modules that implement one or more of the processes, methods, or functions of the application(s) described herein.

In some embodiments, application 112 may interact with third party applications executing on external system 150 to import data and information from external systems 150. For example, instructions for executing one or more or a portion of one or more of the third party functions, processes, methods, and/or software modules may be stored at the platform server 110. Such interaction may be provided by an importer module included as a plug-in in the application 112 for retrieving data in a first format associated with an external system 150 and converting the data into a second format associated with the platform server 110. An example importer module may be provided as an API and/or SDK as described above. Alternatively, or in combination, the importer module may include data scraping instructions for extracting data from a human-readable output generated by processes executed at the external systems 150. In various embodiments, the data scraping instructions may be web scraping instructions for extracting data from web services provided by the external systems 150.

FIG. 2A is a schematic block diagram of an example of a vehicle information system for installation on-board a vehicle that may comprise a portion of or the entirety of the redirection system of FIG. 1 in accordance with the present disclosure.

FIG. 2A shows an example generic vehicle information system 210 (referred to herein as system 210) that can be configured for installation aboard a vehicle 200. The system 210 may be configured to provide an internal network system within the vehicle 200. The internal network system (also referred to as a vehicle communication network) in various embodiments may be implemented as an intranet and local area network; however other implementations are possible for example as described in connection to FIG. 2B below. The network is both intranet/LAN internal to the aircraft. Internet access by that system is desirable in order to ensure redirection instructions can be sent to ground-based systems.

When installed on an aircraft, system 210 may comprise an aircraft passenger IFE and/or IFEC system. While FIG. 2A illustratively depicts an embodiment where vehicle 200 is implemented as an aircraft, the term “vehicle” is not to be so limited. It will be appreciated that the “vehicle” may refer to any and all types of vehicles providing a mode of transportation including, but not limited to, personal transportation vehicles (e.g., automobiles, boats, motorcycles, etc.) and vehicles of common carriers, such as airplanes, passenger trains, buses, cruise ships, sightseeing vehicles (e.g., ships, boats, buses, cars, etc.), or any other moving vehicle.

System 210 comprises a content source 212 and one or more user interface systems 130 (e.g., user interface systems 130 of FIG. 1) communicatively coupled with a real-time content distribution system 216. The content distribution system 216 may provide the internal network system within the vehicle 200 for coupling the user interface systems 130 to media server system 218. User interface systems 130 may comprise one or more of in-seat devices and/or PEDs having wireless communication capability through which passengers of the vehicle (e.g., passengers, crew members, or other persons carried by the vehicle 200) may interact with the system 210. The content source 212 may include one or more internal content sources, included in a media server system 218 installed aboard the vehicle 200, one or more remote (or ground-based) content sources 220 external from the vehicle 200, or a distributed content system (e.g., a distributed cloud system). The media server system 218 and computer system 236 can be provided as or as part of an information system controller 219 (as shown in FIG. 2B) for providing overall system control functions for system 210 and/or for providing connectivity functionality, including information transmitted from user interface systems 130 to media server system 218, as desired.

The information system controller 219 may include one or more servers and databases which host and/or execute one or more of the various functions, processes, and/or methods described herein. Example services (sometimes referred to herein as IFE and/or IFEC services or functionality or vehicle entertainment services or functionality) offered by system 210 includes, but is not limited to, wired or wireless communication connectivity (such as in-flight Intranet and Internet), information, entertainment (e.g., multimedia entertainment services such as video, movies, television programming, audio, games, etc.), communications (e.g., telephone, VoIP, messaging, etc.), payment services, and/or other system services during travel aboard vehicle 200.

In some embodiments, system 210 provides wireless connectivity to a ground-based server system 240. The ground-based sever system 240 may be one or more external systems (e.g., external systems 150 of FIG. 1) and may comprise dedicated servers and databases, or may instead be part of a cloud infrastructure, which utilize shared resources of one or more servers for executing and/or supporting the vehicle entertainment functionality. For example, the media server system 218 of the information system controller may comprise the platform server 110 for hosting application 112 and data stores 114. In some embodiments, the platform server 110 may be distributed across the media server system 218 and the ground-based server system 240. As such, the media server system 218 may host and/or execute one or more of the various functions, processes, and/or methods described herein locally at the vehicle 200 and store information thereof in local data stores for transmission to a ground-based server system 240. The ground-based server system 240 may host and/or execute the one or more of the various functions, processes, and/or methods described herein.

In some embodiments, the information system controller may also comprise or be communicatively connected to a backend application (e.g., application 112) and/or one or more databases (e.g., data store(s) 114)). For example, media server system 218 may include one or more servers that host one or more backend application platforms for interfacing with user interface systems 130. The media server system 218 transmits or serves these user interface systems 130 in response to requests from user interface systems 130 over the content distribution system 216. In some embodiments, the interfaces may be served in the form of backend server application, in which case multiple user interfaces systems may be served in a sequential manner. For example, a passenger may access a software application executed on the user interface system 130 to request and respond to media server system 218, which causes backend server application to perform the requested functions. These executed functions may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases that are locally accessible to media server system 218, remotely accessible from remote content source 220, or ground-based server system 240.

Multimedia content available from the content sources 212 and/or remote content source 220 provide for two-way communications (e.g., bidirectional communications), such as real-time access to the Internet 250 and/or telecommunications systems (e.g., cellular telecommunication systems). Other content available from the content sources 212 may include television programming content, music content, podcast content, photograph album content, audiobook content, and/or movie content without limitation. Content as shown and described herein is not exhaustive and is provided herein for purposes of illustration only and not for purposes of limitation. Multimedia content can comprise any conventional type of audio and/or video content, such as stored (or time-delayed) content and/or live (or real-time) content. The multimedia content can include geographical information.

Being configured to distribute and/or present the content provided by content sources 212, system 210 can communicate with the content source 212 and/or remote content source 220 in real time and in any conventional manner, including via wired and/or wireless communications. System 210 and the remote content source 220, for example, can communicate directly and/or indirectly via an intermediate communication system, such as a connectivity communication system 226. Connectivity communication system 226 may provide wireless bidirectional communications, for example, data signals comprising content for system 210. In some embodiments, the bidirectional communication may be a bidirectional communication link over the Internet or other wireless communication protocol. System 210 thereby can receive content from remote content source 220 and/or ground-based server system 240 via data signal 222 and/or transmit (upload) content via data signal 224 (which may be referred to collectively as a bidirectional communication link), including navigation and other control instructions. The remote content source 220 and ground-based server system 240 are shown as having access to the Internet 250 using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. The connectivity communication system 226 may comprise a satellite communication system or any conventional type of wireless communication system, such as a cellular communication system (not shown) and/or an Aircraft Ground Information System (AGIS) communication system (not shown).

To facilitate communications with the remote content source 220, system 210 may also include an antenna system 228 and a transceiver system 230 for bidirectional communication of data (e.g., content, control, information, etc.) with the remote content source 220. The antenna system 228 may be disposed outside of the aircraft, such as an exterior surface of a fuselage 232 of the vehicle 200. The antenna system 228 can receive content from the remote content source 220 and provide the data, as processed by the transceiver system 230, to a computer system 236 of the information system controller. For example, the transceiver system 230 may include a transmitter having an encoder, a modulator and an up-converter for encoding, modulating, and up-converting data signals from the content distribution system 216 to antenna system 228 and to the remote content source 220 as signals 224. The transceiver system 230 may also include a receiver having a decoder, a demodulator and a down-converter for decoding, demodulating and down-converting signals received by the antenna system 228 from the connectivity communication system 226 into content 234, such as, data signals including video, audio, multimedia, internet, and any content corresponding to functionality of the system 210. While only one transceiver system 230 is shown, a plurality of transceiver systems may be included to enable simultaneous reception of signals from a plurality of transponders. The components of the subsystems included in the transceiver system 230 may be partially or fully integrated and/or separately implemented.

Content in the form of data signals received by the antenna system 228 may be communicated to the computer system 236 and passed to the media server system 218 and/or directly to one or more of the user interface systems 130 as content 234, instructions 254, and/or control signals 256, as desired. Although shown and described as being separate systems for purposes of illustration, the computer system 236 and the media server system 218 can be at least partially and/or fully integrated.

User interface systems 130 may be communicatively coupled to the content distribution system 216 via one or more corresponding access points 258. User interface systems 130 may include a display device configured to display or otherwise present content 234 to a passenger, for example, via a GUI for generating screens, pages, or webpages. The user interface system 130 includes a hardware interface to connect to an access point 258 that provides a wired and/or a wireless connection for the user interface system 130. One or more user interface systems 130 may comprise a software application that a passenger downloads and installs onto their associated PED to receive and view content 234, provide use instructions 254, or receive control signals 256 via an access point 258 or may be preprogrammed into the user interface system 130. The user interface system 130 may be utilized by the passenger to enter or input passenger instructions 254 to interact with content 234 and control the manner in which the selected content 234 is received and/or presented.

The user interface system 130 can include an input/output system (not shown) for permitting the passenger to communicate with system 210, such as via an exchange of control signals 256 and passenger instructions 254. For example, the input system can permit the passenger to enter one or more passenger instructions 254 for controlling the operation of system 210. Illustrative passenger instructions 254 can include instructions for initiating communication with the media server system 218 to perform one or more functions described herein, instructions for selecting content 234 (e.g., inputting travel variables and/or selecting delivery options), and/or instructions for scheduling and/or viewing presentation of selected content 234.

If a fee is required for accessing the content 234, establishing bidirectional communication connectivity, or for any other reason, payment information likewise can be entered via the input/output system. Access to functions of the media server system 218 may require authentication via user credentials (e.g., passwords, biometrics, usernames, etc.) provided via an input device of the user interface system 130. The input/output system can be provided in any conventional manner and typically includes a touch screen, microphone (e.g., voice input commands), camera (e.g., gesture and/or facial recognition) one or more switches (or pushbuttons), such as a keyboard or a keypad, and/or a pointing device, such as a mouse, trackball, or stylus.

FIG. 2B is a schematic block diagram illustrating an example content distribution system in accordance with the present disclosure. FIG. 2B illustrates content distribution system 216 for the system 210. The content distribution system 216 couples and supports communication between the information system controller 219, and the plurality of user interface systems 130. Thus, in various embodiments, the content distribution system 216 may provide for an internal network system of vehicle 200.

The content distribution system 216, for example, can be provided as a conventional wired and/or wireless communication network, including a telephone network, a local area network (LAN), a wide area network (WAN), a campus area network (CAN), personal area network (PAN) and/or a wireless local area network (WLAN) of any kind. Exemplary wireless local area networks include wireless fidelity (Wi-Fi) networks in accordance with Institute of Electrical and Electronics Engineers (IEEE) Standard 522.11 and/or wireless metropolitan-area networks (MANs), which also are known as WiMax Wireless Broadband, in accordance with IEEE Standard 522.16. Preferably being configured to support high data transfer rates, the content distribution system 216 may comprise a high-speed Ethernet network, such as any type of Fast Ethernet (such as 100 Base-X and/or 100 Base-T) communication network and/or Gigabit (such as 1000 Base-X and/or 1000 Base-T) Ethernet communication network, with a typical data transfer rate of at least approximately one hundred megabits per second (100 Mbps) or any other transfer rate. To achieve high data transfer rates in a wireless communications environment, free-space optics (or laser) technology, millimeter wave (or microwave) technology, and/or Ultra-Wideband (UWB) technology can be utilized to support communications among the various system resources, as desired. In various embodiments, the internal network system provided by the content distribution system 216 includes a local area network (LAN) providing access to an intranet, which may further provide connected user interface systems 130 access to the Internet.

As illustrated in FIG. 2B, the content distribution system 216 can be provided as a plurality of area distribution boxes (ADBs) 260, a plurality of floor disconnect boxes (FDBs) 262, and a plurality of seat electronics boxes (SEBs) (and/or video seat electronics boxes (VSEBs) and/or premium seat electronics boxes (PSEBs)) 264 being configured to communicate in real time via a plurality of wired and/or wireless communication connections 266. The content distribution system 216 likewise can include a switching system 268 for providing an interface between the content distribution system 216 and the information system controller 219. The switching system 268 can comprise a conventional switching system, such as an Ethernet switching system, and is configured to couple the information system controller 219 with the area distribution boxes 260. Each of the area distribution boxes 260 is coupled with, and communicates with, the switching system 268. In addition, the content distribution system 216 includes one or more wireless access points (WAPs) (258A to 258N) connected in communication with the switch system 268 for wireless distribution of content to user interface systems 130, such as for example, PEDs.

Each of the area distribution boxes 260, in turn, may be coupled to, and communicates with, at least one floor disconnect box 262. Although the area distribution boxes 260 and the associated floor disconnect boxes 262 can be coupled in any conventional configuration, for example, the associated floor disconnect boxes 262 are disposed in a star network topology about a central area distribution box 260 as illustrated in FIG. 2B. Each floor disconnect box 262 is coupled with, and services, a plurality of daisy-chains of seat electronics boxes 264. The seat electronics boxes 264, in turn, are configured to communicate with the user interface systems 130. Each seat electronics box 264 can support one or more of the user interface systems 130.

The switching systems 268, the area distribution boxes 260, the floor disconnect boxes 262, the seat electronics boxes (and/or video seat electronics boxes (VSEBs) and/or premium seat electronics boxes (PSEBs)) 264, the antenna system 228, the transceiver system 230, the content source 212, the information system controller 219, and other system resources of the system 210 are provided as line replaceable units (LRUs). The use of LRUs may facilitate maintenance of the system 210 because a defective LRU can simply be removed from the system 210 and replaced with a new (or different) LRU. The defective LRU thereafter can be repaired for subsequent installation. Advantageously, the use of LRUs can promote flexibility in configuring the content distribution system 216 by permitting ready modification of the number, arrangement, and/or configuration of the system resources of the content distribution system 216. The content distribution system 216 likewise can be readily upgraded by replacing any obsolete LRUs with new LRUs.

The content distribution system 216 can include at least one FDB internal port bypass connection 270 and/or at least one SEB loopback connection 272. Each FDB internal port bypass connection 270 is a communication connection 266 that permits floor disconnect boxes 262 associated with different area distribution boxes 260 to directly communicate. Each SEB loopback connection 272 is a communication connection 266 that directly couples the last seat electronics box 264 in each daisy-chain of seat electronics boxes 264 for a selected floor disconnect box 262 as shown in FIG. 2B. Each SEB loopback connection 272 therefore forms a loopback path among the daisy-chained seat electronics boxes 264 coupled with the relevant floor disconnect box 262.

The various aspects of the present disclosure may be implemented without using FDB 262. When FDB 262 is not used, ADB 260 communicates directly with SEB 264 and/or information system controller 219 may communicate directly with SEB 264 or the seats. The various aspects of the present disclosure are not limited to any specific network configuration.

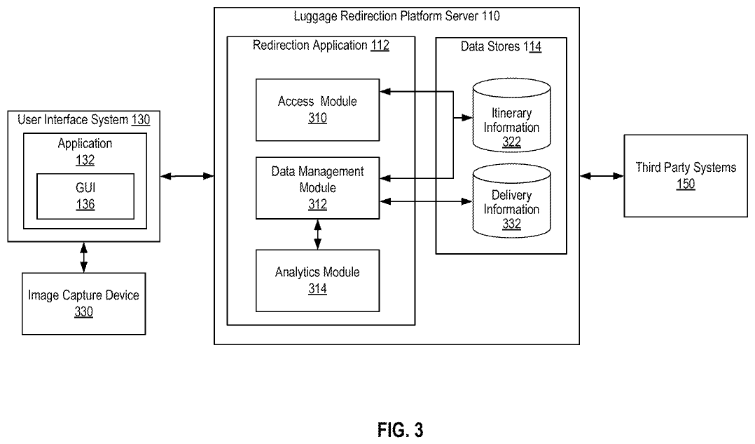

FIG. 3 schematically illustrates an example platform environment in accordance with the present disclosure. FIG. 3 illustrates a computing environment 300 including the user interface system 130 and a platform server 110 as described above in connection with FIG. 1. In accordance with various embodiments herein, the user interface system 130 may communicate with platform server 110 to redirect luggage while the passenger is traveling, such as for example, carried by vehicle 200 or waiting for a connecting flight. The application 112 receives inputs from the user interface system 130 and generates one or more luggage redirection offers, which are transmitted to the user interface system 130 and presented by the application 132. The passenger may utilize the application 132 of the user interface system 130 to select from a redirection offer, which causes the application 132 to generate command instructions including the selection to the platform server 110. The application 112 may then package the selection into a message which is stored in the data stores 114 for immediate and/or delayed transmission to the ground. In various embodiments, the user interface system 130 is able to communicate inputs and receive information from the application 112 over the wireless connection provided by the system 210, which provides the environment 300 the capability to redirect luggage delivery and provide information regarding status of delivery.

In various embodiments, the communications and transactions between the various components described herein may be provided via an internal network, for example, the vehicle communication network provided by the content distribution system 216 as described above. Furthermore, the internal network may provide external Internet access to the system and components carried by the vehicle to ensure redirection instructions are sent to ground-based systems with sufficient time before the luggage reaches the ground and begins transport to its final destination. While, embodiments herein are described in connection to an internal network, it will be appreciated that various embodiments may be similarly performed on any network, for example, as described boave in connection to FIGS. 1-2B.

The platform environment 300 may be a computing environment hosted by, for example, platform server 110 of FIG. 1, and may be executed thinly or thickly by application 112 and/or application 132. The application 132 can include instructions that, when executed by a processor, displays GUI 136. The passenger may interact with GUI 136 via an input device coupled to the user interface system 130 to generate screens, webpages, and other interfaces for receiving inputs. The application 132 may then transmit the inputs to the platform server 110 for performing the various functions described herein. For example, the user interface system 130 may generate GUI 136, by application 132 functioning as a thin or thick client. In one embodiment, the user interface system 130 includes application 132 installed on the user interface system 130 (e.g., a PED and/or in-seat device) as a software application defined by instructions stored in the local data store 134. In this embodiment, the user interface system 130 locally executes the instructions to generate GUI 136, through which passenger may interact with screens displayed by the GUI to redirect luggage and/or passenger preferences and parameters. Alternatively, in some embodiments, the application 132 may be a web-browser application through which the user interface system 130 may access the application 112 implemented as a browser-based portal application. In this embodiment, the GUI 136 of the client application 132 generates screens displaying webpages hosted by the platform server 110 for interacting with the application 112. Passenger inputs may include any interaction with the application 132, for example, instructions and commands as described above in connection to FIG. 1 and passenger data or information input in response to prompts from the application 112 or otherwise. Passenger data may include, but is not limited to, passenger credentials usable for authenticating access to the application 132 and/or application 112, itinerary identifying information, luggage identifying information, and delivery parameters. Screens generated by the GUI 136 may include textboxes, text areas, drop-down menus, check boxes, sliders, etc. where passenger input data may be provided.

Itinerary identifying information may include, for example but not limited to, boarding pass information (e.g., record locator or reservation code, ticket number, etc.) and flight information (e.g., flight times, departing destination, arriving destination, flight numbers, operating airline identifiers). In some embodiments, itinerary information may also include accommodation information, such as a location and identification of where the passenger is staying (e.g., home, a hotel, AirBnb®, etc.). In some embodiments, the user interface system 130 may include or be communicatively coupled to an image capture device 330, such as a camera, that can be utilized to capture an image of a boarding pass and extract the necessary information therefrom. In some embodiments, the user interface system 130 may transmit the scan to the application 112, which may extract the necessary information therefrom. Application 132 may comprise computer readable instructions that scans the image and extracts itinerary identifying information displayed on the boarding pass. The boarding pass may also include a bar code that the application 132 may scan to extract itinerary identifying information. In some embodiments, a passenger may have an electronic boarding pass that may be stored in a local data store 134 of the user interface system 130. The electronic boarding pass may be loaded to or otherwise accessed by the application 132 and used to obtain itinerary identifying information therefrom.

Luggage identifying information may include a unique luggage code associated with each piece of luggage. For example, each piece of luggage may be assigned a unique luggage code when the luggage is processed at a check-in location. The unique luggage code may be attached to each piece of luggage for tracking purposes. The code may be attached, for example, by a label or tag that contains the code. The tag or label may be in the form of a barcode, a QR code, or other uniquely identifiable code that is attached to the luggage (e.g., a luggage tag), an RFID tag that is attached to the luggage, or other electronically detectable devices attached each piece of luggage. A passenger may input the unique identifying code via an input device or the application 132 may extract the unique identifying code via an image captured by the image capture device 330. The luggage identifying information may be supplied by an airline or an airport at the time the passenger checks in or at an earlier time such as when the passenger books a flight (e.g., delivered electronically with the boarding pass or in a separate electronic communication). The luggage identifying information may be stored in a database, for example, hosted by an airline operator system (e.g., one of external systems 150) and associated with itinerary identifying information. As such, the passenger may be linked to the itinerary and each piece of luggage. Furthermore, itinerary identifying information and/or luggage identifying information may be used to identify and retrieve information regarding the luggage.

Delivery parameters may also be supplied by the passenger via GUI 136. Delivery parameters may include, but are not limited to, desired delivery destinations, delivery time parameters, pricing parameters, desired delivery service providers, and delivery instructions information.

Based on one or more of the above-described inputs, the application 112 may generate one or more redirection offers. The user interface system 130 displays the redirection offers to the passenger via the GUI 136 and receives an input selecting one or more offers and/or filter instructions to sort through the redirection offers based on deliver parameters, travel variables, and/or delivery variables. The user interface system 130 may communicate command signals including instruction to process the selected redirection offer(s) to the platform server 110. The platform server 110 may process the command signals to package the selected redirection offer with redirection delivery instructions and update luggage delivery instructions in the data store 114.

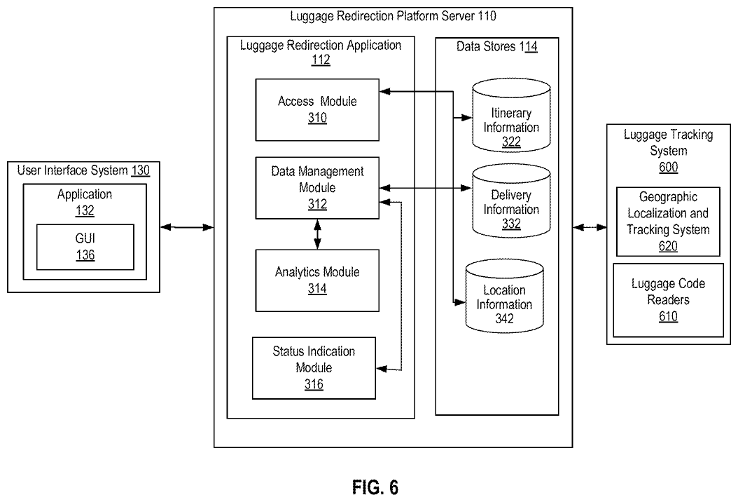

As illustrated in FIG. 3, application 112 may include a plurality of software modules, each comprising computer-readable instructions for executing functions associated therewith. For example, the application 112 may comprise an access module 310, a data management module 312, and an analytics module 314. In some embodiments, the application 112 may also include a status indication module 316, for example, as shown in FIG. 6 discussed below. As illustrated, the platform environment 300 may include the application 112 coupled to one or more data stores 114. In the illustrative example, the data store(s) 114 may include, at least, a data store 322 configured to store travel itinerary information and a data store 332 configured to store luggage delivery information. The data stores 322 and 332 may be included in a single data storage device, separate data storage devices, or distributed in a plurality of data storage devices.

The access module 310 may include instructions for providing passenger access to the platform server 110. The access module 310 may include instructions for providing passenger access to the platform server 110, based on credentials and/or identifying information received from the user interface system 130. In some embodiments, the passenger may enter passenger credentials, such as username, passwords, biometrics, etc. for authenticating access to the application 132, which are validated against credentials stored in one of the data stores 114. In other embodiments, access to the platform server 110 and the functions performed therein may be granted based on itinerary information. For example, a first screen generated by the GUI 136 may prompt the passenger to provide one or more pieces of itinerary identifying information (e.g., a record locator or reservation code, ticket number, flight number, departure city, etc.) before permitting further access to the functions executed by the platform server 110. The provided itinerary information may be validated against information stored in itinerary information data store 322 and/or verified against information accessed through an airline operator system (e.g., one of the third party systems 150). In some embodiments, access may be granted based on only itinerary information, only passenger credentials, or a combination of both (e.g., one entered prior to the other)

The data management module 312 may include instructions for receiving data inputs from a user interface system 130, storing data in data store(s) 114, obtaining data from data store(s) 114, and obtaining third party information from external (e.g., third party) systems 150. The data management module 312 may include one or more importer modules as described above configured to retrieve data from third party systems, which may be used as delivery variables and/or travel variables. The data management module 312 may also receive passenger inputs comprising delivery parameters. The data management module 312 may also obtain data from a database of vehicle 200, for example, flight data where the vehicle 200 is an aircraft.

The data store 322 may store itinerary information in association with itinerary identifying information. For example, the data store 322 may be configured to store itinerary information representative of travel arrangements for a plurality of passengers. The itinerary information may be stored in association with a record identifier usable to retrieve itinerary information for a given itinerary. The record identifier may be a unique itinerary code, such as a reservation number, issued to passenger upon booking a flight(s). The itinerary information may identify passenger(s) involved, departure airport(s), departure time(s), flight information for each leg, connecting information, arrival airport(s), arrival time(s), delays affecting times, reroutes affecting locations, etc. The itinerary information may also identify accommodations and/or intermediate destinations (e.g., rental car locations, or other locations where the passenger may travel following completion of their flight), for example, where such arrangements are made through the entity that generated the itinerary information.

The itinerary information may also include luggage identifying information of one or more pieces of luggage that has been checked in as part of the itinerary. That is, when a passenger checks in under a given itinerary, unique luggage codes may be generated for each piece of luggage and the code may be associated with in the itinerary information.

In some embodiments, itinerary information and the itinerary identifying information associated therewith may be received from the user interface system 130 based on passenger inputs and stored in the data store 322. In some embodiments, itinerary information may also be generated by a third party system 150, for example, an airline operator system. For example, a passenger may select travel arrangements from a webpage hosted by the airline operator system and the airline operator system may generate itinerary information including the selected arrangements, associate the information with a record locator, and store the information in association with the code in a database of the airline operator system. The record locator may be provided to the passenger with a confirmation of the booking. The itinerary information may be uploaded to data store 322 prior to take off and during travel. Furthermore, changes in the itinerary information (e.g., delays or reroutes) may be updated at the airline operator system and updated in the data store 322 via system 210. The data management module 312 may retrieve the itinerary information from the airline operator system using the record locator received from the user interface system 130 (or extracted from an image) and store the information in the data store 322. The access module 310 may also be utilized to retrieve the itinerary information to validate the information received from user interface system 130.

The data store 332 may store luggage delivery information in association with the luggage identifying information. For example, each piece of luggage has corresponding luggage delivery instructions stored in data store 332 in association with the luggage identifying information for each piece of luggage. The data management module 312 may thus be able to retrieve luggage delivery information from the data store 332 using luggage identifying information. Additionally, all luggage associated with a given itinerary may be retrieved as a group, for example, by using the itinerary identifying information, because the itinerary identifying information may include luggage identifying information for all luggage checked-in under the itinerary, as described above. Example luggage delivery instructions may include delivery destinations for each piece of luggage, destination descriptors indicative of type of destination (e.g., residential or business location, passenger or friend's home, rental property, hotel, etc.), expected time of delivery and/or delivery time window, identification of luggage transportation services, other descriptive delivery instructions (e.g., leave with front desk, ring door bell, descriptions of access location, etc.). Luggage delivery instructions may also include conventional instructions to process luggage to baggage claim, for example, where the passenger has not elected to use luggage delivery services.

The data management module 312 may include instructions to forward obtained information to the analytics module 314, which may contain instructions for processing the data and performing various functions of the application 112. The analytics module 314 provides for generating one or more luggage redirection offers based on the information from the data management module 312. For example, the analytics module 314 may generate offers based on comparing and evaluating location destination for the flight, flight data (e.g., such as passenger manifests), luggage tracking information, and data obtained from third party services providers (for example, based on partnerships or otherwise).

The analytics module 314 may evaluate passenger supplied deliver parameters to determine passenger preferences and generate redirection offers based thereon. For example, the user interface system 130 may provide passenger defined pricing parameters, desired delivery service provides, delivery destinations, and timing parameters to the data management module 312, which are forwarded to the analytics module 314 configured to evaluate these delivery parameters to generate one or more luggage redirection offers that meet the passenger's preferences. The delivery preferences may be applied to each individually to each piece of luggage, to one or more pieces, or to the luggage as a group as checked-in under the itinerary.

In some embodiments, the analytics module 314 may also generate one or more redirection offers for one or more or all pieces of luggage based on travel variables, for example, as determined from itinerary information associated therewith. For example, the analytics module 314 may evaluate a passenger's itinerary information determine travel variables such as an estimated time of arrival, delays in travel plans, and/or reroutes to propose a delivery location and delivery time. In some embodiments, the analytics module 314 may generate one or more offers based on travel variables and luggage delivery information existing within the data store 322. For example, the analytics module 314 may evaluate the delivery information in view of changes to itinerary information and generate updated redirection offers as a result of changes in the itinerary information, for example, due to either passenger modifications or other system modifications (e.g., delayed or cancelled flight, etc.). Furthermore, the travel variables, as described above, may be combined with the delivery preferences to generate the one or more redirection offers.

In some embodiments, the analytics module 314 may also utilize delivery variables based on third party information to update redirection offers. For example, the data management module 312 may retrieve delivery variables, such as, price quotes, available luggage transportation service, available timing parameters, weather conditions, etc. from third party systems 150, which the analytics module 314 may evaluate to generate one or more redirection offers. The analytics module 314 may generate redirection offers based on evaluating both the passenger defined delivery parameters, travel variables, and third party delivery variables. In some embodiments, the analytics module 314 may generate multiple offers and may rank and/or filter them, for example, based on passenger supplied travel variables and/or delivery variables.

The analytics module 314 may include instructions for transmitting the update offers to the data management module 312, which may then transmit the configurations to the user interface system 130 for review by a passenger via the GUI 136.

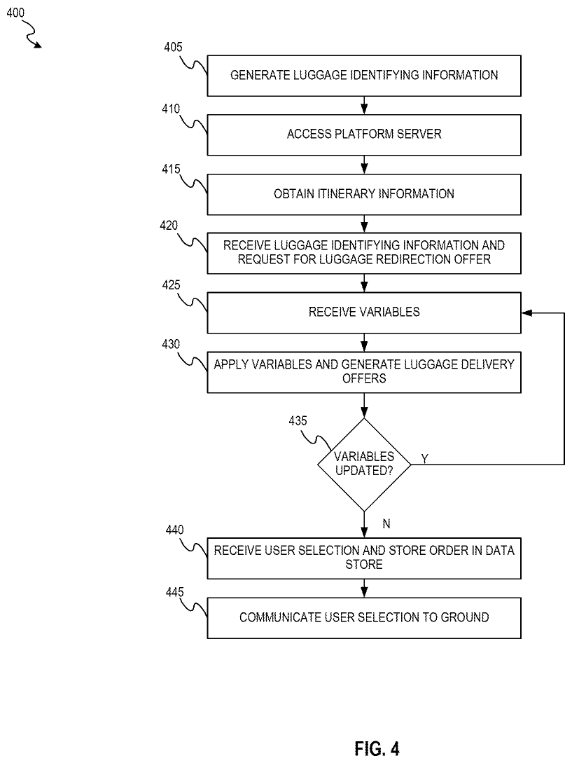

FIG. 4 is an example method flow for redirecting luggage delivery whilst in mid-travel in accordance with the present disclosure. The process 400 may be performed by one or more devices disclosed herein, such as for example, system 100 illustrated in FIG. 1, discussed above. For example, the process 400 may be executed in part or wholly by the platform server 110 executing application 112 and/or the application 132 executed at the user interface system 130. In various embodiments, the process 400 may be performed partially or completely by the plurality of software modules described in connection to FIG. 3.

Upon booking an itinerary a passenger may be provided itinerary identifying information, as described above. The itinerary information may be recorded and stored in association with the itinerary identifying information. In some embodiments, the itinerary information and itinerary identifying information may be stored in a data store (e.g., data store 322) and/or at a third party system (e.g., an airline operator system).

At block 405, luggage identifying information is generated for each piece of luggage. For example, upon arrival at a luggage check-in location prior to a flight, the airline operator system may be accessed to retrieve itinerary information using the itinerary identifying information supplied by the passenger. The passenger may also be supplied one or more boarding passes containing itinerary identifying information displayed thereon or may have been supplied a boarding pass prior to check-in. In some embodiments, the boarding pass may be a physical paper boarding pass and/or an electronic boarding pass loaded onto a passenger's PED. The passenger's luggage may be processed and each piece may be assigned unique luggage identifying information at this time. The luggage identifying information may be stored with the itinerary information, for example, using the itinerary identification information. The luggage identifying information may also be physically attached to each corresponding piece of luggage. Prior to departure, the luggage identifying information and itinerary information may be uploaded to system 210 of vehicle 200 to be included in flight data (such as a flight manifest) and stored in the media server system 218 and/or itinerary information data store 322.

Following receiving the unique luggage code at block 405 or any time prior to collecting the luggage at baggage claim at a final arrival airport, the passenger may wish to redirect their luggage from previously arranged services. The following steps of process 400 may be performed using any user interface system 130, for example, a PED and/or an in-seat device integrated into the vehicle 200 and connected to system 210. The user interface system 130 may be connected to the system 210 via a browser-based portal application or a preinstalled software application while aboard vehicle 200 and connected to on-board communication network or may be coupled to the platform server via any network connection as described above.

At block 410 the passenger may access the platform server 110, for example, using a user interface system 130. The passenger may be required to input passenger credentials into the user interface system 130 to authenticate access via the access module 310. In some embodiments, the platform server 110 may prompt the passenger to enter itinerary identifying information prior to permitting access to the functionality of the application. The access module 310 may receive the itinerary information and confirm that the itinerary information exists within the data store 322 and/or an airline operator system. In some embodiments, the itinerary identifying information may be provided via a passenger input into graphical user interface 136. In some embodiments, the identifying information may be extracted from an image of a boarding pass acquired using an image capture device coupled to the user interface system 130. In some embodiments, the user interface system 130 may transmit the scan to the application 112, which may extract the necessary information therefrom. In yet other embodiments, where an electronic boarding pass is stored on the user interface system or loaded into the application 132, the identifying information may be extracted from the stored data.

At block 415 the data management module 312 obtains the itinerary information from the data store 322, for example, using the received itinerary identifying information.

At block 420, the data management module 312 obtains luggage identifying information for each piece of luggage associated with the obtained itinerary identifying information. In some embodiments, the luggage identifying information may be supplied via user interface system 130, for example, by passenger input via GUI 136, extracted from an image captured using an image capture device (e.g., an image of a barcode and/or QR code included in the luggage tag attached to the luggage), and/or read from an RFID reader coupled or the like. In some embodiments, the luggage identifying information may be obtained from data store 322 based an association with the obtained itinerary information (e.g., by using the itinerary information to retrieve the luggage identifying information). For example, itinerary information may be used to retrieve luggage identifying information associated therewith. In some embodiments, the process 400 automatically proceeds after retrieving the associated luggage identifying information, while in others the passenger may be presented the obtained luggage identifying information and select one or more pieces of luggage to redirect by selecting one or more of the present luggage identifying information.

Also, at block 420 (as the same operation, a previous operation, or a subsequent operation), the application 112 receives a request from the user interface system 130 for one or more luggage redirection offers. In some embodiments, the request at 420 may be a first instance of requesting luggage delivery services. For example, prior to and/or at check-in the passenger may have elected to collect their luggage at baggage claim and thus did not arrange for luggage delivery services, in which case the delivery instruction in data store 332 may be conventional instructs to process luggage to baggage claim. However, at this point the passenger may now wish to register and/or schedule for luggage delivery services. Alternatively, block 420 may include a request to modify existing luggage delivery arrangements, for example, by changing a delivery time, delivery location, etc.

In some embodiments, the luggage identifying information may be received prior to the request. That is, luggage identifying information for one or more pieces of luggage may be received before the request luggage redirection. The process 400 may be executed for multiple pieces of luggage at once, for example, by receiving luggage identifying information for multiple piece of luggage at block 420. Alternatively, the process 400 may be executed for each piece of luggage individually, for example, by receiving luggage identifying information for a single piece of luggage at block 420. In other embodiments, the request may be received prior to the luggage identifying information for one or more pieces of luggage.

At block 425 one or more variables may be received by the data management module 312. For example, delivery parameters may be defined by the passenger via GUI 136. For example, the delivery parameters may include an indication of a delivery destination, desired time of delivery, desired delivery server provider, pricing parameters, etc. In some embodiments, delivery parameters received at block 425 may be included with the request received at block 420. For example, where the request is to modify an existing delivery arrangement at block 420, the request may include travel variables at block 425 that may be different from the previously arranged delivery. In some embodiments, the request and any included travel variables may be received by the data management module 312.

Variables may also include delivery variables derived based on information obtained from third party systems 150. Example delivery variables include, but are not limited to, third party pricing parameters, indication of surge-pricing in effect (e.g., price fluctuations based on distance and/or supply and demand levels), available luggage transportation services, available delivery destinations or delivery restrictions (e.g., restrictions on distance from pick up that delivery can be made, restriction on destinations such as whether recreational location delivery or business location is possible). The obtained third party information may include logistic parameters for arranging delivery, availability information indicating when certain services are available, pricing information including indications of surge pricing based on demand, etc.

Travel variables may also be based on the obtained itinerary information. For example, travel variables may be extracted from itinerary information and include flight arrival locations, connecting flight information and locations, expected arrival times, accommodation information, rental car arrangements, etc. The itinerary information may be changed based on updates to flight data by the airline operator or within the system 210, for example, due to flight cancellations, delays, reschedules, changes in routes, etc. The itinerary information may also be changed via passenger input through the user interface system 130.

At block 430, the variables are applied to generate one or more luggage redirection offers. For example, the analytics module 314 may generate all available luggage delivery services that are available for a given flight arrival location and a given arrival time. The data management module 312 may supply the variables to the analytics module 314, which can identify one or more luggage redirection offers that meet criteria defined by the variables. The one or more redirection offers may be provided to the data management module 312 and transmitted to the user interface system 130. The user interface system 130 may display the one or more offers to the passenger via the GUI 136.

At block 435, the platform server 110 determines whether the variables have been updated. For example, the passenger may input additional delivery parameters and/or modify the previously provided delivery parameters. These updates may be part of a filtering operation to sort through the one or more generated luggage redirection offers to narrow down the displayed offers to a preferred redirection offer. In some embodiments, the update may be due to a change in the passenger's desired plans. In some embodiments, the update may be in response to changes in information obtained from third party systems 150, for example, a change in pricing, availability, etc., may occur that is propagated into the generated offers thereby updating the offers to reflect this change. If block 435 determines the variables have been updated, the process 400 returns to block 425 and repeats the process. Otherwise, the process 400 continues to block 440.

At block 440, the data management module 312 receives a passenger selection of one or more luggage redirection offers. The passenger may select one luggage redirection offer for one or more pieces of luggage associated with the itinerary. Thus, different luggage redirection offers may be selected for each piece of luggage thereby defining separate luggage delivery instructions on a per luggage basis. A given set of instructions may be applied to one, one or more, or all pieces of the luggage associated with the itinerary. In some embodiments, process 400 may be performed for a single piece of luggage. Thus, where multiple pieces of luggage are part of an itinerary, the process 400 may be performed separately for each piece of luggage. In another embodiment, at block 440 the passenger may select redirection offers for each piece of luggage. That is, the passenger may select a redirection offer and then identify one or more pieces of luggage (e.g., using the luggage identifying information) to be delivered based on the selected offer.

Furthermore at block 440, upon receiving the passenger selection, the analytics module 314 may package the selected redirection offer with delivery instructions corresponding thereto to generate a luggage delivery order. The luggage delivery order includes delivery instructions based on the selected offers and luggage identifying information for the luggage to be delivered in accordance with the instructions. If prior delivery instructions exist for the identified luggage, the prior instructions are either modified in accordance with the passenger selection or deleted and replaced with newly generated instructions. The delivery order may also include a confirmation indicative of acceptance of the delivery instructions and confirmation that payment will be made or has been processed. The luggage delivery order and instructions therein may then be stored in data store 332.

At block 445, the selection is communicated to the ground. For example, the data management module 312 generates one or more messages comprising the luggage delivery order and communicates the one or messages to ground-based server systems. In some embodiments, the ground-based server systems may be one or more third party systems 150 for processing, executing and delivering of the luggage in accordance with the instructions included in the selected offer (e.g., a delivery service provider system). In some embodiments, the luggage delivery order may be communicated immediately to the ground, for example, where the user interface system 130 is in communication with the platform server 110 via a cellular or other ground based network connection or, if on-board vehicle 200, via system 210 where ground-based communications are enabled or otherwise available. In some embodiments, if connectivity to the ground is not available while on-board vehicle 200, the order may be queued in the media server system 218 and communicated upon landing.

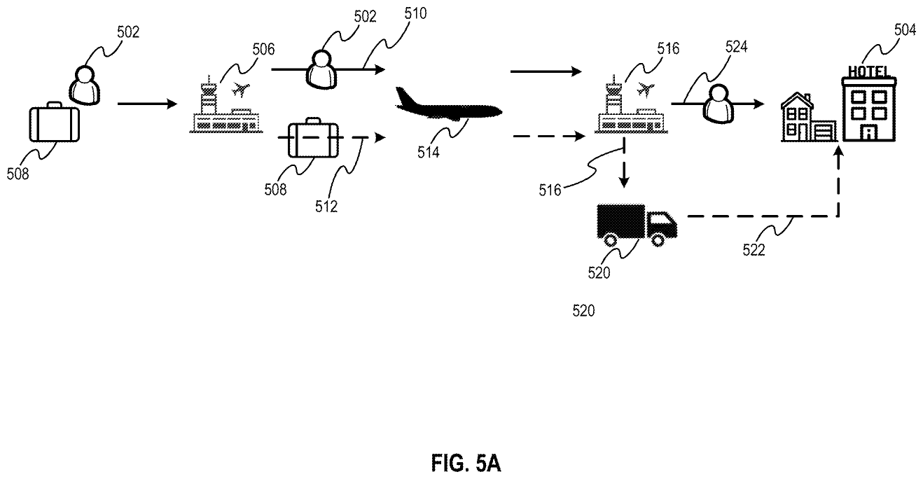

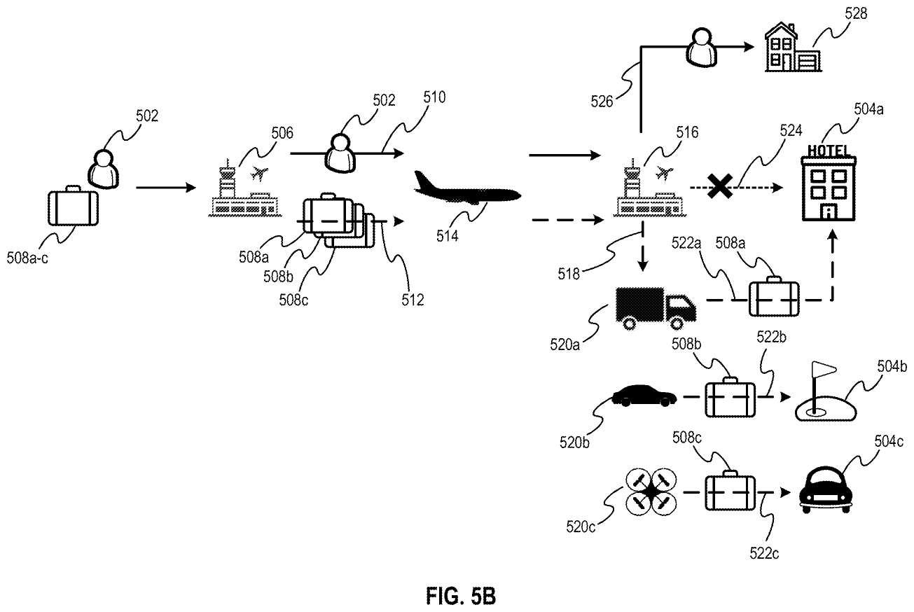

FIGS. 5A and 5B are block diagrams illustrating example processes of the luggage redirection system in accordance with the present disclosure. FIGS. 5A and 5B illustrates multiple example stages of travel experienced by a passenger 502 and luggage 508 under an itinerary.

As illustrated in FIG. 5A, passenger 502 is traveling to final destination 504 (e.g., a hotel in this illustrative example) in accordance with an itinerary booked prior to leaving home. The passenger 502 travels to a departure airport 506 carrying luggage 508 for departure on a flight 514. FIG. 5A is described with reference to a single piece of luggage 508, it will be appreciated that the passenger 502 may carry one or more pieces of luggage and the processes described herein will be equally applicable to each piece of luggage. At the departure airport 506, the passenger checks in luggage 508 at a check-in area, for example, by using itinerary identifying information for the flight. The itinerary identifying information retrieves the passenger's itinerary, identifies the departure flight, any connecting flights and locations, arrival locations, and various departure and arrival times on the itinerary.

At or before this time, luggage 508 is issued luggage identifying information (step 405 of FIG. 4), such as a unique luggage code, and the passenger or another person attaches the coded to the luggage. The luggage identifying information is also stored in association with the itinerary information in the airline operator system. At a point following check-in and before take-off, the luggage identifying information and itinerary information are included in flight data (e.g., flight manifest) and uploaded to the aircraft (e.g., to system 210 of FIG. 2A). The luggage 508 may then be scanned by luggage code readers for tracking purposes when each piece of luggage leaves the check-in area.

While the passenger 502 commutes from the check-in area, through security, and waits for take-off via path 510, the luggage 508 travels along path 512 to aircraft 514. For example, the luggage 508 may be delivered to a luggage sorting area. Additional luggage code readers may be located in this area configured to scan the luggage identifying information when each piece of luggage arrives at the luggage sorting area. The luggage 508 is then loaded on luggage transport vehicles, which may also have luggage code readers configured to scan the luggage identifying information when the luggage 508 leaves the luggage sorting area. The luggage is then delivered by a luggage transport vehicle to aircraft 514 on which the luggage is then loaded, which may include luggage code readers configured to scan the unique luggage identifying information when the luggage 508 arrives at and/or is placed within an aircraft 514.

If passenger 502 wished to have the luggage 508 delivered to the final destination 504, conventional systems required that electing and scheduling these services prior to check-in at departure airport 506 and/or by predetermined amount of time prior to take-off of the first flight of an itinerary. Advantageously, the passenger 502 has access to the redirection system 100 described herein via a user interface system 130, such as a PED carried by the passenger 502 or an in-seat device installed in aircraft 514 once the passenger is on-board. Once on-board, the user interface system 130 is communicatively coupled to the IFE or IFEC system (e.g., system 210). Accordingly, while aircraft 514 is in route to arrival airport 516, the passenger may access the luggage redirection system 100 (step 410 of FIG. 4) via either a software application installed on the user interface system 130 or a browser-based portal application to elect and schedule delivery services while in route to the arrival airport 516, for example, as described above in connection to FIGS. 3 and 4.

While FIG. 5A is described as comprising a single flight at aircraft 514, it will be understood that the flight 514 may comprise one or more flights and aircrafts. For example, the itinerary may include multiple connecting flights each represented as aircraft 514, where the first flight departs from airport 506 and the final leg of the connecting flight arrives at airport 516.

Once aircraft 514 has landed at arrival airport 516, luggage 508 travels along path 518 to a vehicle 520 operated by a delivery service provider as arranged by the luggage redirection system 100 in accordance with the redirection offer selected by the passenger (block 445 of FIG. 4). For example, the luggage 508 may be unloaded onto luggage transport vehicles. The luggage 508 may then be transported by a luggage transport vehicle to a luggage sorting area, sorted, and then departs from the luggage sorting area by conveyor, luggage transport vehicle, or otherwise. The luggage 508 may then arrive at a luggage pickup area, where it can be picked up by luggage handler and loaded onto a vehicle 520 operated by delivery service provider. The vehicle 520 may then carry the luggage 508 along path 522 and deliver the luggage 508 at final destination 504 in accordance with the delivery instructions. The passenger 502 may travel along a different path 524 to the final destination, which may include intermediate stops along the way (e.g., an office location, sightseeing, etc.). Thus, the passenger need not wait at a baggage claim area at arrival airport 516 nor be required to carry their luggage 508 during the commute to the final destination 504.

Each of the above described stages may comprise one or more respective luggage code readers configured to scan luggage identifying information when the luggage 508 arrives and/or departs from the location. Furthermore, the luggage 508, aircraft 514, and/or delivery service provider may comprise, have affixed thereto, carry, or otherwise be associated with a geographic localization signal received configured for use in geographic location tracking as described below in connection to FIG. 6.

As illustrated in FIG. 5B, the passenger 502 carries one or more pieces of luggage, for example, luggage 508a-508c as part of travel plans defined by a previously booked itinerary. FIG. 5B illustrates an example process of the luggage redirection system similar to that described in connection with FIG. 5A., except that while on aircraft 514 the passenger 502 decides that each piece of luggage 508a-c is to be delivered to one or more different final destinations 504a-504c using one or more different delivery service providers operating vehicles 520a 520a-520c.

In the illustrative example, passenger 502 may be traveling as part of a mixed business and pleasure trip and booked an itinerary accordingly. As an example, prior to boarding aircraft 514 the passenger 502 was planning to arrive at airport 516, pick up a rental car at rental location 504c, and travel immediately to hotel 504a. The passenger 502 may also be planning trips to office 528 and recreational location 504b (illustratively depicted as a golf course) during the trip. The passenger may have planned to collect luggage 508a-c at baggage claim and/or previously arranged for delivery services. However, while in flight, a meeting is scheduled at office 528 along path 526 immediately following arrival at airport 516. Thus, passenger 502 may wish to redirect the luggage 508a-c since passenger 502 will not be able to drop of luggage at hotel 504a.

Conventional systems would not allow for such a change as services must be selected prior to check-in at departure airport 506 and/or by predetermined amount of time prior to take-off of the first flight of an itinerary. Advantageously, the passenger 502 has access to the luggage redirection system 100 described herein. Accordingly, while aircraft 514 is in route to arrival airport 516, the passenger may access the luggage redirection system 100 (step 410 of FIG. 4) to schedule and/or modify delivery services while in route, for example, as described above in connection to FIGS. 3 and 4.

For example, the passenger 502 may input one or more delivery preferences into the system 100. Such delivery preferences may be an indication that one or more pieces of luggage 508a-c are to be delivered to separate locations at destinations 504a-c. In the illustrative example, luggage 508a may be overnight luggage, luggage 508b may be a set of golf clubs, and luggage 508c may be a briefcase or files needed for the meeting. Using the luggage identifying information for each piece of luggage, the passenger 502 may input a desired destination for each piece of luggage, such as the hotel 504a for luggage 508a, a recreational location 504b such as golf course 504b for luggage 508b, and car rental pick-up location 504c for luggage 508c. The passenger 502 may also input various other delivery preferences, such as estimated arrival time and/or desired delivery time windows to ensure each piece of luggage is at the desired location at the desired time and pricing parameters for constrained costs of delivery.

The luggage redirection system 100 may then obtain third party delivery variables from third party systems 150 and other travel variables. Such delivery variables may include, for example, available delivery service providers (e.g., commercial delivery, private car, ride-share, robotic and/or drone delivery, etc.); expected delivery times and/or windows; pricing quotes for each delivery option. Example travel variables may include, for example, estimated time of arrival and weather forecast at arrival airport 516, etc.

The luggage redirection system 100 may evaluate the received delivery preferences, obtained third party delivery variables, obtained travel variables to generate one or more redirection offers for each piece of luggage 508a-c. These offers are generated, transmitted, and displayed on the user interface system 130 and the passenger selects one or more of the offers. For example, as illustrated in FIG. 5B, the passenger may select a commercial van delivery service 520a for delivering luggage 508a along path 522, with a desired delivery time; ride-share delivery service provider 520b for delivering luggage 508b to location 504b; and drone delivery service provider 520c to deliver luggage 508c to location 504b. Once an offer is selected for each piece of luggage 508a-c, an order is generated for each luggage redirection offer and communicated to the luggage delivery service provider as described above in connection to FIGS. 3 and 4 for delivery according to the instructions included in the delivery order.

The above described process may be performed at any point prior to any point after take-off of the first leg of a trip. For example, where an itinerary includes connecting flights, the above described luggage redirection may be executed along any leg of the flight and may be performed any number of times. Thus, if there is a change in flight route, such as delayed, cancelled, or changes in connecting flights (or first flight), the passenger may be able to utilize the systems described herein to modify and/or schedule luggage delivery to any desired destination. FIGS. 5A and 5B are illustrative examples of only some of the scenarios where the systems described may provide advantages over existing systems. One skilled in the art will appreciate that systems described herein may be equally and advantageously applicable to numerous other implementations and scenarios.

FIG. 6 schematically illustrates another example platform environment in accordance with the present disclosure. The platform environment of FIG. 6 is substantially similar to the environment 300 of FIG. 3, except that the platform server 110 also comprises a status indication module 316, a data store 342, and is communicatively coupled to a luggage tracking system 600. System 600 provides for continuous tracking of luggage delivery status and location in real time through multiple stages of travel, from check-in to delivery at the final destination. The multiple stages of travel may include various stages in which the luggage change location and handlers (e.g., from check-in to loaded on a plane, changes in planes, unloading to luggage handlers, to delivery service, etc.). Thus, tracking may occur through stages having tracking ability, such that the luggage may be tracked from when the luggage leaves the passenger's possession (e.g., the multiple stages described in connection to FIGS. 5A and 5B) to when the luggage is delivered (e.g., at the ultimate destination identified in the delivery information described above).

The luggage tracking system 600 includes a one or more luggage identification readers 610 (sometimes referred to herein as luggage code readers) and a geographic location tracking system 620. The luggage tracking system 600 may be coupled to a data store (not shown) for storing luggage tracking information within the system 600. The luggage tracking system 600 is communicatively coupled to the platform server 110, for example, via a ground-based wireless communications network and/or an IFEC system, such as system 210. Location information from the luggage tracking system 600 may be obtained by the data management module 312 (e.g., in a manner similar to third party systems 150) and can be stored in data store 114, such as location information data store 342 for storing location information of each piece of luggage. The data management module 312 may forward location information, itinerary information, and delivery information to the status indication module 316. The status indication module 316 may then evaluate the received information to generate notification information of a current location for a given piece of luggage and a status of delivery of the luggage. The notification information can be stored in the data store 342 and/or communicated to the user interface system 130. The GUI 136 may then display the status to the passenger.

The luggage tracking system 600 is configured to track when luggage at an airport has arrived at and/or departed from each of one or more locations (e.g., stages as described above in connection to FIGS. 5A and 5B) at an airport. The locations may be of any type, such as a luggage check-in area, a luggage sorting area at departing and/or arriving airport, within an airplane, a luggage pickup area, within control of a delivery service provider operated vehicle, and/or a delivery location.

To facilitate this functionality, the unique identifying information assigned to each piece of luggage, as described above, can be used for tracking purposes. This assignment may be facilitated by attaching a label or tag to the luggage that contains the identifying information or by placing a device within the luggage that contains the identifying information. As described above, different identifying information may be attached using various devices, for example, a luggage tag including the unique identifying information printed thereon, devices that contain unique identifying information and that can be attached to or placed within a piece of luggage, an RFID tag attached to the luggage, etc.

The luggage identification readers 610 may be provided at one or more stages of the travel (e.g., as described above in connection to FIGS. 5A-5B) for tracking the luggage and may be of any type. For example, the luggage code readers 610 may be optical bar code readers, optical QR code readers, and/or RFID tag readers capable of detecting and reading the unique identifying information from each piece of luggage. In some situations, a luggage handler may need to manually operate the reader 610 within a read range of the unique identifying information. Alternatively, the tag containing the code may be positioned in a predetermined location on the luggage (e.g., placed there by the passenger per instructions or by airline staff) such that when the luggage is conveyed through an automated route, the stationary optical reader is positioned to be able to read the code. One or more of either implementation may be utilized at each stage.

When tracking both the arrival and departure of luggage from a particular location, multiple readers may be used, one at the entryway to the location to track the arrival and one at the exit from the location to track the departure. Multiple readers may be used at the entry and/or exit when needed due to multiple and/or very wide entry or exit pathways.

The geographic location tracking system 620 is configured to track the geographic location of the luggage during one or more stages of delivery. For example, each piece of luggage may be associated with a localization signal receiver configured to receive geographic location information indicative of the physical geographic location of the receiver and transmit the location information to the luggage tracking system 600. The geographic location tracking system 620 may then determine the location of the luggage based on the association with the receiver. The localization signal receiver may be a local or global localization system, for example, GPS systems, triangulation systems, Bluetooth Low Energy beacons, or any system known in the art that can be used to remotely determine and track a geographic location of a receiver. In some embodiments, the localization signal receiver may be attached to the luggage, for example, as part of the luggage tag. In other embodiments, or in combination, the localization signal receiver may be coupled to a vehicle carrying and/or carried by a luggage handler in possession of the luggage.

The luggage tracking system 600 is configured to generate luggage location information. Luggage location information may indicate a location at which the luggage has arrived or from which the luggage has departed as well as possibly the time of each event. Luggage location information may also include itinerary information, such as but not limited to, the name of the passenger and/or flight information, such as the flight number, the flight departure airport and/or city, the flight arrival airport and/or city, the anticipated and/or actual departure time, and/or the anticipated and/or actual arrival time. Luggage location information may also be an indication of the handler currently in possession of the luggage, such as an airline and/or the delivery service provider; where the luggage has been picked up by the delivery service provider; the luggage location information may include an indication of the vehicle (e.g., license plate, VIN, serial numbers, or other identifying information of the vehicle); an operator's identifying information (e.g., a name, employee number, or other identifying information of person operating the delivery vehicle); estimated or actual time and location of pick up, expected time of arrival and destination of drop off, and indication of completed delivery or pending. The luggage location information may also include geographic information of the current location and/or route of travel of the luggage during delivery. The luggage tracking system 600 may communicate the luggage location information data store associated with the luggage tracking system 600.

The data store 342 may store location information for each piece of luggage in association with corresponding unique luggage identifying information. Thus, the data management module 312 may be able to retrieve location information for a given piece of luggage using the luggage identifying information. The location information may be uploaded from the luggage tracking system 600 to the data store 342. In some embodiments, location information may be updated in the data store 342 in real-time as the location changes in the luggage tracking system. In other embodiments, or combined with other embodiments, the data management module 312 may query the luggage tracking system for a current location of the luggage. In other embodiments, the location information is updated when or in response to bidirectional communications become available.

The status indication module 316 may include instructions for generating status information indicative of a delivery status of each piece of luggage. For example, the status indication module 316 may receive luggage identifying information for a given piece of luggage and query the data store 342 for a current location of the luggage. The current location may be provided to the user interface system 130 and displayed to the passenger via GUI 136, for example, as a textual notification and/or a graphical notification including a geographic map showing real-time geographic route traveled by the luggage. As another example, the status indication module 316 may also receive delivery and itinerary information for the given piece of luggage, compare the location information with the delivery and itinerary information to determine a status (e.g., on a given aircraft, estimated arrival at the airport, in luggage sorting area, out for delivery, delivered, etc.) representative of a stage of travel. This information may be displayed to the passenger via GUI 136.

Status and location information may be transmitted to the user interface system 130 based on a request from the user interface system, for example, through passenger inputs requesting a current location. In some embodiments, or in combination, the status and location information may be communicated to the user interface system as notification of changes in the status and location. For example, when the luggage changes location between stages of travel, a notification message may be generated by the status indication module 316 and automatically transmitted to the user interface system 130. The notification message may then be displayed for review and/or interacted with by the passenger for further information and details (e.g., to request detailed location information and map data).

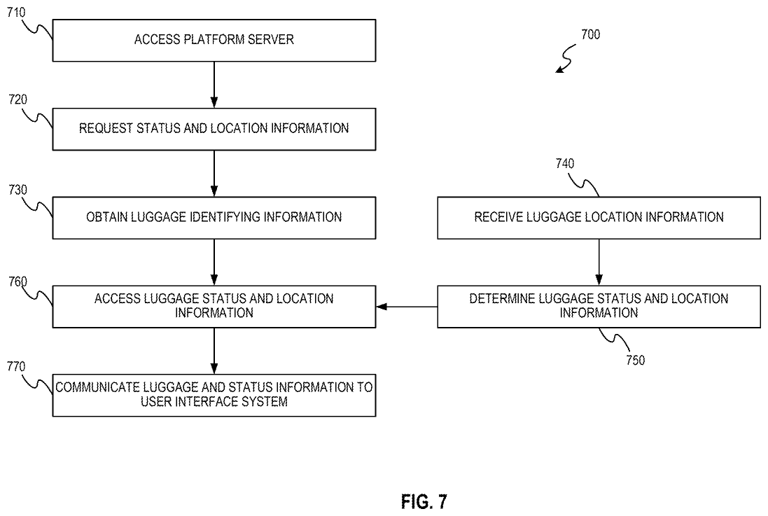

FIG. 7 is an example method flow for providing status and location information whilst in mid-travel in accordance with the present disclosure. The process 700 may be performed by one or more devices disclosed herein, such as for example, system 100 illustrated in FIG. 1, discussed above. For example, the process 700 may be executed in part by application 132 of user interface system 130 hosted by the platform server 110 executing application 112. In various embodiments, the process 700 may be performed partially or completely by the plurality of software modules described in connection to FIG. 6.

At block 710 the passenger may access the platform server 110, for example, using a user interface system 130. Access at block 710 may be granted in a manner similar to that described in connection to block 410 of FIG. 4. At block 720, the user interface system 130 may transmit a request or query for status and location information for a given piece of luggage, for example, by using the luggage identifying information. At block 730 luggage identifying information may be received identifying each piece of luggage for which location and status information is being requested. In some embodiments, the luggage identifying information may be supplied via user interface system 130, for example, by passenger input via GUI 136, extracted from an image captured using an image capture device (e.g., an image of a barcode and/or QR code included in the luggage tag attached to the luggage), and/or read from an RFID reader coupled to the user interface system 130. In some embodiments, the luggage identifying information may be obtained from data store 322 based on the granted access to the passenger. In some embodiments, the passenger may supply the itinerary identifying information, which may be used by the platform server 110 to retrieve one or more luggage identifying information associated therewith.

At block 740, luggage location information is received at the platform server 110. For example, location information may be received from the luggage tracking system 600 as described above in connection to FIG. 6 and stored in the data store 342. At block 750, luggage status and location information for the given piece of luggage is determined based on the received location information. For example, as described above, the status indication module 316 may determine the status and location information based on the current location from the luggage tracking system 600, the delivery information from data store 332, and itinerary information from data store 322. Once the status is determined and stored in data store 342, the status and location information for the queried luggage identifying information may be accessed at block 760 and communicated to the user interface system 130 at block 770 as one or more status messages comprising the luggage identifying information and associated the status and location information. The user interface system 130 may then display the received information via the GUI 136.

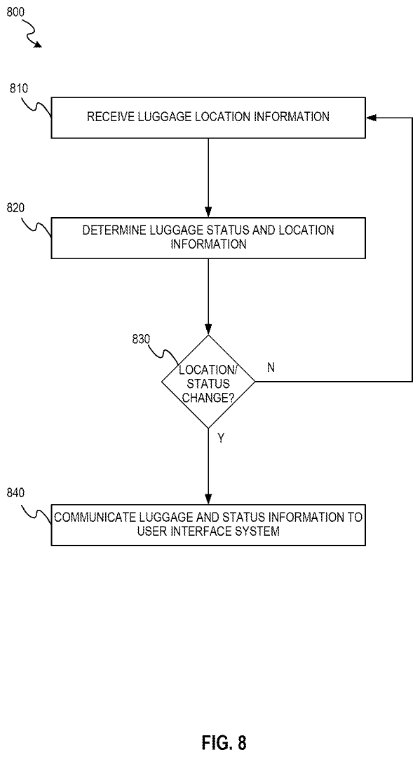

FIG. 8 is another example method flow for providing status and location information whilst in mid-travel in accordance with the present disclosure. Process 800 may be similar to process 700, except that process 800 illustrates an example method for automated notification of changes in status and location information. The process 800 may be performed by one or more devices disclosed herein, such as, for example, system 100 illustrated in FIG. 1, discussed above. For example, the process 800 may be executed in part by application 132 of user interface system 130 hosted by the platform server 110 executing application 112. In various embodiments, the process 800 may be performed partially or completely by the plurality of software modules described in connection to FIG. 6.

At block 810, luggage location information is received at the platform server 110. For example, location information may be received from the luggage tracking system 600 as described above in connection to FIG. 6 and stored in the data store 342. At block 820, luggage status and location information for the given piece of luggage is determined. For example, as described above, the status indication module 316 may determine the status and location information based on the current location from the luggage tracking system 600, the delivery information from data store 332, and itinerary information from data store 322. Once the status is determined and stored in data store 342, the received luggage status and location information is compared against the previously stored information to determine if a change in location and/or status of the luggage has occurred. If a change is detected at block 830, a notification message including the status and location information is automatically generated and communicated to the user interface system 130 at block 840. The user interface system 130 may then display the notification within the GUI 136 of application 132 or generate a popup notification or banner notification that automatically displays the notification message to the user.

FIG. 9 illustrates a block diagram of a computing system, in accordance with various aspects of the present disclosure. FIG. 9 is a high-level block diagram showing an example of the architecture of a processing system 900 (also referred to herein as a computing device) that may be implemented as any one or more of the components of the embodiments described herein. The processing system 900 can represent platform server 110, a user interface system 130, a third party system 150, media server system 218, computer system 236, or other systems and components as described herein. Note that certain standard and well-known components which are not germane to the present aspects are not shown in FIG. 9.

The processing system 900 includes one or more processor(s) 902 and memory 904, coupled to a bus system 905. The bus system 905 shown in FIG. 905 may be an abstraction that represents any one or more separate physical buses and/or point-to-point connections, connected by appropriate bridges, adapters and/or controllers. The bus system 905, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1366 bus (sometimes referred to as “Firewire”) or any other interconnect type.

The processor(s) 902 are the central processing units (CPUs) of the processing system 900 and, thus, control its overall operation. In certain aspects, the processors 902 accomplish this by executing software stored in memory 904. A processor 902 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 904 represents any form of random access memory (RAM), read-only memory (ROM), flash memory, or the like, or a combination of such devices. Memory 904 includes the main memory of the processing system 900. Instructions 906 may be used to implement the functions and processes described above, for example, in FIGS. 1-8. For example, the software stored in memory 904 may be software architecture or software modules described in FIGS. 3 and 6 for providing luggage delivery and redirection and location tracking. The memory 904 may be coupled to the processor 902, and the processor 902 may be configured to execute instructions (e.g., software) stored in the memory 904 to carry out the various aspects of the luggage delivery and redirection system 100 described herein.

Also connected to the processors 902 through the bus system 905 are one or more internal mass storage devices 910, and a network adapter 912. Internal mass storage devices 910 may be, or may include, any conventional medium for storing large volumes of data in a non-volatile manner, such as one or more magnetic or optical based disks, flash memory, or solid-state drive. Mass storage 910 may be representative of, for example, one or more of data store(s) 114, 134. 154, 332, 334, 342, etc. The information and data stored therein may be encrypted to ensure secure storage of private information, for example, using any encryption algorithm. Example algorithms include, but are not limited to, Data Encryption Standard (DES), TripleDES, RSA, Advanced Emption Standard (AES), or the like.

The network adapter 912 provides the processing system 900 with the ability to communicate with devices remote with respect to a given processing system 900 (e.g., over a network and may be, for example, an Ethernet adapter or the like). That is, if processing system 900 is implemented as the platform server 110, then the network adaptor 910 provides the platform server 110 the ability to communicate with user interface systems 130 via, for example, the internal network, or with external systems 150 using antenna 228. Communication signals transmitted over the network may be secured, for example, through encryption algorithms and cryptographic key exchange protocols. For example, data or information transmitted or received during the processes 400, 700, or 800 or otherwise described in the present disclosure may be encrypted and secured to ensure privacy. Example cryptographic key exchange protocols may include symmetric-key algorithms, asymmetric-key algorithms, Internet Key Exchange (IKE), Dlffie-Hellman Key Exchange, or the like.

The processing system 900 also may include one or more input/output (I/O) devices 908 coupled to the bus system 905. The I/O devices 908 may include, for example, a display device, a touch screen device, a microphone for voice commands, a camera for detecting gestures and other non-tactile inputs, a keyboard, a mouse, etc. The I/O device may be in the form of a handset having one or more of the foregoing components, such as a display with a real or virtual keyboard, buttons, and/or other touch-sensitive surfaces.

The processing system 900 also may include or otherwise be communicatively coupled to a display 914 (e.g., a display monitor or screen) coupled to bus system 905 by a display adaptor 916. The display adaptor 916 may include a graphics adapter to improve the performance of graphics intensive applications and a video controller. The processor 902 may execute instructions in memory 904 to generate a graphical user interface, such as GUI 136, for presenting one or more screens, for example, webpages or other visually presented information. The processing system 900 may also include a graphics-processing unit 918. Graphics-processing unit 918 may be a specialized electronic circuit designed to manipulate and alter memory to accelerate the creation of images in a frame buffer intended for output to a display, for example, outputting images via GUI 136. In general, graphics-processing unit 918 is efficient at manipulating computer graphics and image processing, and has a highly parallel structure that makes it more effective than general-purpose CPUs for algorithms where processing of large blocks of data is done in parallel.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more.

The various illustrative logical or functional blocks and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative blocks and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

What is claimed is:

1. A system for redirecting luggage while in the midst of travel, the system comprising:
a content distribution system configured to provide a vehicle communication network for a vehicle;
at least one data store coupled to the vehicle communication network, the at least one data store configured to store luggage delivery instructions in association with luggage identifying information; and
at least one processor coupled to the vehicle communication network and to at least one memory programmed with executable instructions, the at least one processor configured to execute the executable instructions to:
receive, from a user interface system carried by the vehicle and coupled to the vehicle communication network, luggage identifying information and delivery parameters representative of passenger preferences,
generate one or more luggage redirection offers based on the received delivery parameters and transmit the one or more luggage redirection offers to the user interface system,
receive a selection of a luggage redirection offer from the one or more luggage redirection offers from the user interface system,
generate and store, in the at least one data store, luggage delivery instructions in association with the received luggage identifying information based on the selected luggage redirection offer, and
send one or more messages to a delivery service provider system, the one or more messages containing information instructing the delivery service provider system to deliver luggage corresponding to the luggage identifying information according to the luggage delivery instructions associated with the luggage identifying information,
wherein the content distribution system, the at least one data store, the at least one processor, and the at least one memory are disposed in the vehicle.

2. The system of claim 1, wherein the at least one processor is further configured to automatically send the one or more messages to the delivery service provider system when communication connectivity is available with systems external to the vehicle.

3. The system of claim 1, wherein the vehicle is an aircraft.

4. The system of claim 3, wherein the content distribution system is included in one of an inflight entertainment (IFE) system and an inflight entertainment and communication (IFEC) system.

5. The system of claim 3, wherein the one or more messages are queued in the at least one data store and sent to the delivery service provider system once the aircraft lands, wherein communication connectivity is not available with systems external to the vehicle until the vehicle lands.

6. The system of claim 1, wherein the user interface system is one of a seatback device, an in-seat device, and a personal electronic device.

7. The system of claim 1, wherein the user interface system comprises at least one device processor and at least device memory storing an application, the application configured to receive the luggage identifying information and the delivery parameters from the passenger, display the one or more luggage redirection offers to the passenger; and receive the selection of the luggage redirection offer.

8. The system of claim 7, wherein the luggage identifying information is retrieved based on an electronic boarding pass stored in the at least one device memory.

9. The system of claim 1, wherein the user interface system is coupled to an image capture device configured to scan the luggage identifying information, and wherein the luggage identifying information is extracted from the scan.

10. The system of claim 1, wherein the at least one processor is further configured to obtain delivery variables from third party systems that are external to the vehicle and generate the one or more luggage redirection offers based on the delivery variables.

11. The system of claim 1, wherein the at least one processor is further configured to receive itinerary information for the passenger, determine travel variables based on the itinerary information, and generate the one or more luggage redirection offers based on the travel variables.

12. The system of claim 1, wherein the at least one processor is further configured to:
receive luggage location information for luggage corresponding to the received luggage identifying information,
determine status and location information for luggage corresponding to the received luggage identifying information and store the determined status and location information in association with the received luggage identifying information, and
generate one or more notification messages comprising the determined status and location information and transmit the one or more notification messages to the user interface system.

13. A method for redirecting luggage while in the midst of travel, the method comprising:
receiving, from a user interface system carried by a vehicle and coupled to a vehicle communication network, luggage identifying information and delivery parameters representative of passenger preferences, the vehicle communication network provided by a content distribution system disposed on a vehicle;
generating one or more luggage redirection offers based on the received delivery parameters and transmitting the one or more luggage redirection offers to the user interface system via the vehicle communication network;
receiving, via the vehicle communication network, a selection of a luggage redirection offer from the one or more luggage redirection offers from the user interface system;
generating and storing, in at least one data store disposed on the vehicle, luggage delivery instructions in association with the received luggage identifying information based on the selected luggage redirection offer; and
sending one or more messages to a delivery service provider system, the one or more messages containing information instructing the delivery service provider system to deliver luggage corresponding to the luggage identifying information according to the luggage delivery instructions associated with the luggage identifying information.

14. The method of claim 13, further comprising automatically sending the one or more messages to the delivery service provider system when communication connectivity is available with systems external to the vehicle.

15. The method of claim 13, wherein the vehicle is an aircraft and the content distribution system is included in one of an inflight entertainment (IFE) system and an inflight entertainment and communication (IFEC) system.

16. The method of claim 15, further comprising queuing the one or more messages in the at least one data store and sending the one or more messages the delivery service provider system once the aircraft lands, wherein communication connectivity is not available with systems external to the vehicle until the vehicle lands.

17. The method of claim 13, wherein the user interface system is one of a seatback device, an in-seat device, and a personal electronic device.

18. The method of claim 13, further comprising obtaining delivery variables from third party systems that are external to the vehicle and generating the one or more luggage redirection offers based on the delivery variables.

19. The method of claim 13, further comprising receiving itinerary information for the passenger, determining travel variables based on the itinerary information, and generating the one or more luggage redirection offers based on the travel variables.

20. The method of claim 13, further comprising:
receiving luggage location information for luggage corresponding to the received luggage identifying information;
determining status and location information for luggage corresponding to the received luggage identifying information and storing the determined status and location information in association with the received luggage identifying information; and
generating one or more notification messages comprising the determined status and location information and transmitting the one or more notification messages to the user interface system.
